(19) United States
(12) Patent Application Publication
(10) Pub. No.: US 2014/0244435 A1
(43) Pub. Date: Aug. 28, 2014

(54) ELECTRONIC COMMERCE METHOD AND ELECTRONIC COMMERCE SYSTEM

(71) Applicant: Panasonic Corporation, Osaka (JP)

(72) Inventors: Hiroshi Yahata, Osaka (JP); Aki Yoneda, Hyogo (JP); Taiji Sasaki, Osaka (JP)

(73) Assignee: Panasonic Corporation, Kadoma-shi, Osaka (JP)

(21) Appl. No.: 14/349,135

(22) PCT Filed: Aug. 6, 2013
(86) PCT No.: PCT/JP2013/004749

§ 371 Date: Apr. 2, 2014

(30) Foreign Application Priority Data
Aug. 10, 2012 (JP) 2012-178200

(51) Int. Cl. G06Q 30/06

(52) U.S. Cl. CPC G06Q 30/0633
USPC 705/26.8

(57) ABSTRACT

An electronic commerce method executed by a computer includes: receiving, from a user, an amount of disposable money usage of which is not determined; selecting, from among one or more products or services, a product or a service having a purchase price lower than or equal to the amount of disposable money, without receiving an instruction from the user; and performing processing of purchasing the product or the service which has been selected, without obtaining permission from the user. For example, an object recognizable by the user is presented to the user, and if purchase processing is performed, the user is notified that the object has performed purchase processing.

### TECHNICAL FIELD

The present invention relates to electronic commerce methods and electronic commerce systems, and in particular to an electronic commerce method and an electronic commerce system executed by a computer,

### BACKGROUND ART

An electronic payment service for making a user's payment (electronic commerce system) has been disclosed which is conventionally used by a user communicating with a terminal connected via a network, using a user terminal (for example, Patent Literature 1),

### CITATION LIST

### Patent Literature

[PTL 1] Japanese Unexamined Patent Application Publication No. 2006-134238

### SUMMARY OF INVENTION

### Technical Problem

Such a conventional electronic commerce system mainly focuses on allowing purchase processing to be performed which properly reflects the intention of a user who is to make a purchase. The conventional electronic commerce system, however, has problems that purchase processing reflecting living activities of users cannot be performed.

In view of this, the present invention provides an electronic commerce method for performing purchase processing reflecting living activities of users.

### Solution to Problem

An electronic commerce method according to an aspect of the present invention is an electronic commerce method executed by a computer, the electronic commerce method including: receiving, from a user, an amount of disposable money usage of which is not determined; selecting, from among one or more products or services, a product or a service having a purchase price lower than or equal to the amount of disposable money, without receiving an instruction from the user; and performing purchase processing of purchasing the product or the service which has been selected, without obtaining permission from the user.

It should be noted that these general and specific aspects may be implemented using a system, a method, an integrated circuit, a computer program, a computer-readable recording medium such as a CD-ROM, or any combination of systems, methods, integrated circuits, computer programs, and recording media.

### Advantageous Effects of Invention

The electronic commerce method according to the present invention allows purchase processing reflecting living activities of users to be performed.

### BRIEF DESCRIPTION OF DRAWINGS

FIG. 1 is an explanatory diagram of a video distribution service according to a supposed technique.

FIG. 2 is an explanatory diagram of a distribution service according to an embodiment.

FIG. 3A is a detailed explanatory diagram of the distribution service according to the embodiment.

FIG. 3B illustrates a hardware configuration of a distribution system according to the embodiment.

FIG. 4 illustrates an example of content related information in the distribution system.

FIG. 5 illustrates an example of sponsor related information in a management information unit of the distribution system.

FIG. 6 illustrates an example of viewer related information in the distribution system.

FIG. 7 illustrates an example of store related information in the distribution system.

FIG. 8 illustrates an example of a workflow when content is added.

FIG. 9 illustrates an example of a workflow when content is played.

FIG. 10 illustrates an example of a workflow of sharing profits between a distributor and a content provider.

FIG. 11 illustrates an example of a workflow when a sponsor advertisement is added.

FIG. 12 illustrates an example of a workflow when a sponsor advertisement is played.

FIG. 13 illustrates an example of a workflow when a store advertisement is added and updated.

FIG. 14 illustrates an example of a workflow when a store advertisement is played.

FIG. 15 illustrates an example of a workflow of sharing profits between a distributor and a store.

FIG. 16 illustrates an example of a workflow when a viewer is added.

FIG. 17 illustrates an example of a workflow when a viewer is updated.

FIG. 18 is an explanatory diagram of advertisement display styles according to viewers.

FIG. 19A illustrates a first example of advertisement display.

FIG. 19B illustrates a second example of advertisement display.

FIG. 19C illustrates a third example of advertisement display.

FIG. 19D illustrates a fourth example of advertisement display.

FIG. 20A illustrates a first example of a superimposed advertisement.

FIG. 20B illustrates a second example of a superimposed advertisement (after paying for purchased product).

FIG. 20C illustrates a third example of a superimposed advertisement (after paying for purchased product).

FIG. 21A illustrates a first example of advertisement preferential display.

FIG. 21B illustrates a second example of advertisement preferential display.

FIG. 21C illustrates a third example of advertisement preferential display.

FIG. 21D illustrates a fourth example of advertisement preferential display.

FIG. 22 is an explanatory diagram of operation for tracking and playing a person in life-size.

FIG. 23 is an explanatory diagram of the distribution service according to the embodiment.

FIG. 24 is an explanatory diagram of the distribution service according to the embodiment.

FIG. 25A illustrates an example of a first configuration of an electronic commerce system according to a variation of the embodiment.

FIG. 25B illustrates an example of a hardware configuration of the electronic commerce system according to the variation of the embodiment.

FIG. 25C is a functional block diagram of the electronic commerce system according to the variation of the embodiment.

FIG. 25D is an explanatory diagram of operation of the electronic commerce system according to the variation of the embodiment.

FIG. 26 illustrates an example of a second configuration of the electronic commerce system according to the variation of the embodiment.

FIG. 27 illustrates an example of learning preference of an individual user by the electronic commerce system according to the variation of the embodiment.

FIG. 28 illustrates an example of optimization of an advertisement by the electronic commerce system according to the variation of the embodiment.

FIG. 29 illustrates an example of learning an act of an individual user by the electronic commerce system according to the variation of the embodiment.

FIG. 30 illustrates an example of accounting by the electronic commerce system according to the variation of the embodiment.

### DESCRIPTION OF EMBODIMENTS

### Underlying Knowledge Forming Basis of the Present Invention

The inventors of the present application have found that the electronic commerce system described in the “Background Art” section has problems as follows.

Recently, video distribution services such as YouTube (registered trademark) and Ustream (registered trademark) have started, which allow an extremely large number of people to easily view various videos on the Internet. These video distribution services widely ask ordinary people to create content and to provide various types of content, stores the content in a video distribution server to distribute the content to many unspecified users. A viewer can find interesting content through a search, for instance, and view the content using video-on-demand.

The above content includes a video with an advertisement, and the advertisement is played being superimposed on the content, before the video is played or while the video is being played. A user is guided to a Web site of a sponsor of the advertisement by clicking the advertisement, if viewing a video leads to the sponsor's sales in the above manner, the sponsor shares a certain amount of profits (revenue sharing) with a video distributor in many cases, and in general, the shared profits from such advertising expenses are used for operating the management of the video distributor.

In addition, it is common to recommend, based on a video viewed by the viewer, a video that the viewer is expected to be willing to view next. Conceivably, attribution information is previously set to individual stored content, and another content viewed by the viewer prior/subsequent to the time when certain content is played is recorded, thereby creating a database including the relevance of such content, which enables recommendation of content to be viewed next.

A cloud-based video distribution server is generally used for such video distribution services, and combinations of widely known elements of information technology (IT) achieve the whole system. To merely provide a general video distribution service as described above does not involve a technique worth specially describing, and the above utility form is technically achieved and provided owing to a control application (program) of a video distribution server.

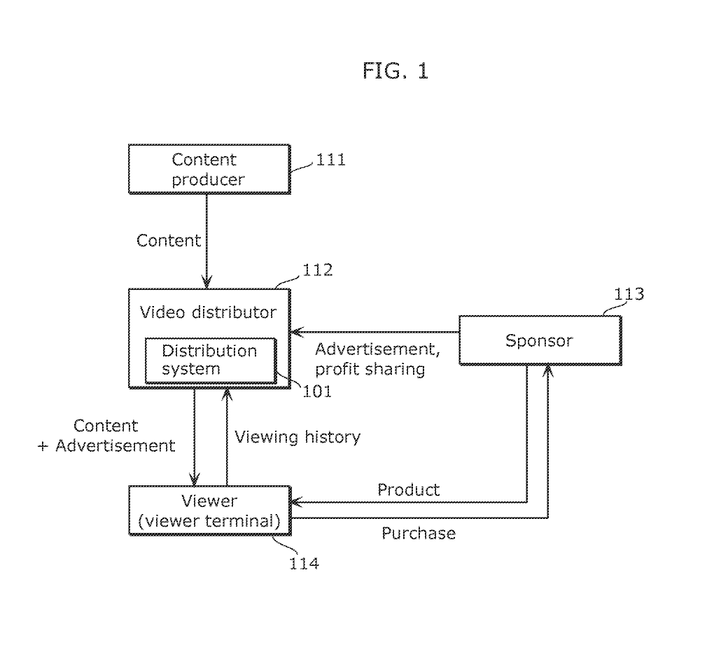

FIG. 1 is an explanatory diagram of a video distribution service according to the technique described above (referred to as “assumed technique”), FIG. 1 illustrates a relationship between a video distributor and a stakeholder.

In the video distribution service according to the assumed technique as illustrated in FIG. 1, a content producer 111 produces content and transmits the produced content to a video distributor 112 (distribution system 101). A sponsor 113 transmits an advertisement to the video distributor 112. The video distributor 112 provides a viewer 114 with both content and an advertisement (for example, the advertisement is superimposed and displayed on the content). The video distributor obtains a viewing history of the viewer 114 if the viewer 114 views content. In addition, if the viewer 114 purchases a product from the sponsor 113, based on a provided advertisement (for example, by clicking the advertisement), the sponsor 113 provides the viewer 114 with the product, and shares a portion of profits with the video distributor 112 (profit sharing).

In the video distribution service according to the assumed technique as illustrated in FIG. 1, viewing tendency, interest, and preference are not sufficiently put in a database based on a viewing history or a viewing style of an individual viewer, thus merely achieving a method of recommending content to be played next according to relevance of content.

It is assumed that the content producer 111 provides content for free, and thus cannot expect directly obtaining reward for producing the content.

Although the sponsor 113 can designate an advertisement along with content, the sponsor 113 cannot present an advertisement to specific viewers based on information such as interest, taste, or preference of individual viewers. In addition, what motivated the viewer to purchase the product first cannot be precisely tracked if, for instance, a viewer purchases a product through other means rather than purchasing the product on a Web site linked from the advertisement.

In addition, retail outlets are not in direct conjunction with such services, and can relay only on mail order sites of their own or selling products at their own stores.

Similar types of content are automatically displayed, which does not allow the viewer 114 to view content according to his/her interest, taste, and preference. For example, a user who wants to see a specific soccer player is often recommended to view a soccer video in which that soccer player does not appear.

In addition, there have been no information services for helping a user to lead a comfortable and convenient life while understanding the user's interest and taste.

In addition, the conventional electronic commerce system focuses on properly performing purchase processing that reflects the intention of a user who is to make a purchase. In other words, the conventional electronic commerce system focuses on safely and properly purchasing a product that a user wants to purchase, and thus pays no attention to the knowledge or a change in the mental state of the user, which is a problem.

In view of this, the present invention provides an electronic commerce method which greatly changes a mental state of a user even beyond his/her knowledge.

In addition, the present invention can provide entirely new functions, values, and business opportunities to stakeholders related to video distribution services (content holders, sponsors, stores, viewers, and distributors).

An electronic commerce method according to an aspect of the present invention is an electronic commerce method executed by a computer, the electronic commerce method including: receiving, from a user, an amount of disposable money usage of which is not determined; selecting, from among one or more products or services, a product or a service having a purchase price lower than or equal to the amount of disposable money, without receiving an instruction from the user; and performing purchase processing of purchasing the product or the service which has been selected, without obtaining permission from the user.

According to this, purchase processing of purchasing a product or a service is performed without permission from the user, using the disposable money usage of which is not determined by the user. After that, the user is provided with a product or a service purchased without his/her permission, using the disposable money usage of which is not determined by the user. Therefore, the user obtains knowledge and experience beyond the range of his/her knowledge, through a product or a service that exceeds the range of his/her knowledge, which greatly changes his/her mental state. Specifically, the user can obtain unknown experience, surprise, joy, happiness, satisfaction, pleasure, and the like. In this manner, a relationship of trust with an object is established for a user, which allows expectation that the user will permit a greater amount of money disposable by an object.

It should be noted that according to the present invention, it is also possible to provide an electronic commerce method which reduces processing load in purchase processing in an electronic commerce system. This is because although receiving processing of receiving from a user information regarding a product or a service to be purchased is performed in conventional purchase processing, such receiving processing is not performed according to the present invention, thus achieving a reduction in processing load by that processing.

For example, the electronic commerce method may further include: presenting, to the user, an object recognizable by the user; and notifying the user, when the purchase processing is performed, that the object has performed the purchase processing.

In this manner, the object presents the user information as if the object has purchased a product or a service. The user feels that the object has selected and purchased the product or the service with the intention thereof, and feels closeness, affection, and gratitude toward the object. Therefore, a mental state of the user is greatly changed.

For example, the electronic commerce method may further include: receiving profile information of the user; and selecting, when the product or the service is to be selected, the product or the service based on the received profile information.

In this manner, a product or a service is selected and purchased based on profile information such as a birthday and a blood type of a user. The mental state of the user is greatly changed due to the product or service being purchased based on his/her own profile (for example, a rose bouquet is given on the user's birthday).

For example, the electronic commerce method may further include: obtaining a reaction of the user to the product or the service purchased by the purchase processing; and selecting, when the product or the service is to be selected after obtaining the reaction of the user, the product or the service based on the obtained reaction of the user.

In this manner, based on the reaction of the user after the user is given the product or the service, a product or a service is selected and purchased thereafter. This allows learning preference of the user, and selection of a product or a service to still more greatly change the mental state of the user (affection and gratitude).

For example, the electronic commerce method may further include notifying the user that the product has been purchased if the product is purchased by the purchase processing, at (i) a time designated as a time on a delivery date for the product or (ii) a time at which the product is to arrive at a destination of the product, the time being estimated based on delivery information indicating which point of a delivery path the product is at in a process of delivering the product purchased by the purchase processing, the delivery information being obtained from a transport company terminal which manages the delivery information.

In this manner, when a product is purchased and the product is delivered to the location of a user, a message is presented at the delivery time. Although the product is delivered by a delivery man of a transport company in fact, the user can feel as if the product is provided by the object.

For example, the electronic commerce method may further include: obtaining advertisement information regarding an advertisement of a product or a service, from an advertisement company terminal; and notifying the user of recommendation to purchase the product or the service indicated by the obtained advertisement information.

In this manner, the purchase of a product or a service is recommended to a user, based on advertisement information. In other words, an advertisement company which wishes to recommend a user to purchase a product or a service can recommend the user to purchase the product or the service by providing advertisement information.

For example, the electronic commerce method may further include: decreasing, if the purchase processing is performed, the amount of disposable money by the purchase price of the product or the service purchased by the purchase processing; and increasing, if a new amount of disposable money usage of which is not determined is received from the user, the amount of disposable money by the new amount of disposable money.

In this manner, the amount of disposable money can be decreased or increased. A more highly priced product or service can be purchased by the user setting a new amount of disposable money.

For example, a terminal used by the user in the electronic commerce method may have a display screen, and the object may be an image object displayed as an image on the display screen of the terminal, and notify the user that the object has performed the purchase processing, by a motion of or a sound from the image.

In this manner, an object is achieved as an image object on the display screen of a computer. The exchange of information and a message with this image object allows the user to have trust, which greatly changes the mental state of the user. In addition, an increase in trust results in a purchase of a more highly priced product or service.

For example, the object may be a robot in a real space, and notify the user that the object has performed the purchase processing, by a motion of or a sound from the robot.

In this manner, the object is achieved as a robot in the real world. The exchange of information and a message with this robot allows the user to have trust, which greatly changes the mental state of the user. In addition, an increase in trust leads to a purchase of a more highly priced product or service.

Furthermore, an electronic commerce system according to an aspect of the present invention includes: a receiving unit configured to receive, from a user, an amount of disposable money usage of which is not determined; a selection unit configured to select, from among one or more products or services, a product or a service having a purchase price lower than or equal to the amount of disposable money, without receiving an instruction from the user; and a purchase processing unit configured to perform processing of purchasing the product or the service which has been selected, without obtaining permission from the user.

In this manner, similar effects to those of the above electronic commerce method are achieved.

It should be noted that these general and specific aspects may be implemented using a system, a method, an integrated circuit, a computer program, a computer-readable recording medium such as a CD-ROM, or any combination of systems, methods, integrated circuits, computer programs or recording media.

The following specifically describes embodiments with reference to the drawings.

The embodiments described below each show a general or specific example. The numerical values, shapes, materials, constituent elements, the arrangement and connection of the constituent elements, steps, the processing order of the steps, and the like described in the following embodiments are mere examples, and thus do not limit the scope of the appended Claims. Therefore, among the constituent elements in the following exemplary embodiments, constituent elements not recited in any of the independent claims defining the most generic part of the inventive concept are described as arbitrary constituent elements.

### EMBODIMENTS

The following describes, using the accompanying drawings, an information distribution service, an information distribution system (content distribution system), and implementation methods thereof according to the present invention.

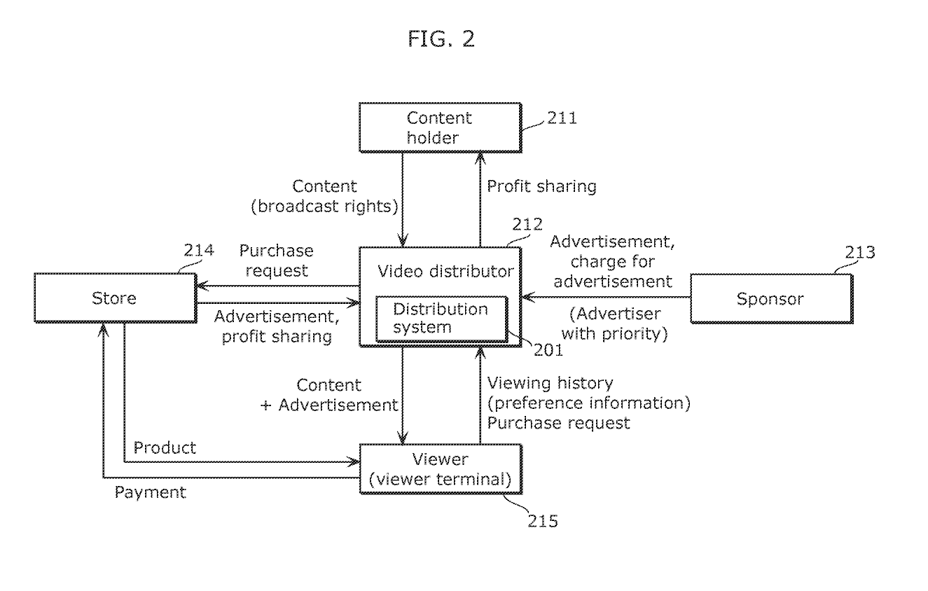

FIG. 1 is an explanatory diagram of a video distribution service according to an existing, assumed technique. FIG. 2 is an explanatory diagram of a distribution service according to an embodiment. FIG. 1 illustrates an overview of a video distribution service according to the assumed technique, whereas FIG. 2 illustrates an overview of a distribution service according to an embodiment.

In the video distribution service illustrated in FIG. 2, a content holder 211 creates content and transmits the created content to a distributor 212 (distribution system 201). A sponsor 213 transmits a sponsor advertisement (hereinafter, also simply referred to as an advertisement) to the distributor 212. A store 214 transmits a store advertisement (hereinafter, also simply referred to as an advertisement) to the distributor 212. The distributor 212 provides a viewer 215 with content together with a sponsor advertisement and a store advertisement (for example, content is displayed having a sponsor advertisement and a store advertisement being superimposed thereon). If the viewer 215 views content, the video distributor will obtain a viewing history. In addition, if the viewer 215 purchases a product based on the provided sponsor advertisement and store advertisement, the distributor 212 receives a purchase request from the viewer 215, and transmits the purchase request to the store 214, and the store 214 sells the product to the viewer 215. The viewer 215 pays the store 214 for the purchased product. The store 214 shares a part of the profits with the distributor 212 (profit sharing).

First, it is necessary to secure the quality and the amount of content which can be distributed, in order to provide a distribution service. In order to secure the quality and amount of content, the distributor which distributes content makes a contract with a content holder which holds content in the present embodiment. Based on this contract, the content holder provides content to the distributor, and at the same time, gives broadcast rights of the content. The distributor counts the number of playing the content, for instance, and shares the profits with the content holder, based on the information.

In this way, even if the content is created by a private individual and is not for commercial use, if that content gains popularity, more persons view the content and the number of times the content is viewed increases. As a result, the content holder can obtain an income. Accordingly, a great number of content pieces with high quality tend to gather at the distributor.

The more content pieces are collected, the more viewers can be attracted. However, it is difficult to begin a pay service while some video distribution services offer viewers free content (alternative means). Consequently, it is possible to use advertisements from sponsors as an income source of the distributor 212 in order to allow viewers to view content for free.

Thus, according to this distribution system, interest, taste, and/or preference are stored as a database in addition to personal information of each viewer. Specifically, preference information is extracted from a viewing history, direct operation by a viewer, or his/her selection, and the extracted preference information is stored. Preference information of viewers is stored in this manner, thereby providing an advertisement exactly suited to each individual viewer.

A sponsor pays the distributor a charge for an advertisement and distributing that advertisement, and here, can also request the distributor to distribute the advertisement to viewers having certain preference.

For example, an advertisement in which idol A appears is delivered only to a viewer interested in idol A, thereby promoting selling more products and services.

In addition, “distributing” content and an advertisement utilizing the Internet differs from what is called “broadcasting” in one direction such as terrestrial broadcasting and satellite broadcasting, and can also provide stores with new business opportunities.

For example, a sponsor can request the distributor to provide an advertisement of his/her store between advertisements, to attract attention from viewers, and share profits with the distributor if there are sales owing to the advertisement. In particular, when a viewer is viewing a video using HTML5 browser on a viewer terminal to which content is distributed, a buy button is displayed on a screen of the viewer terminal (for example, a tablet terminal) while he/she is looking at an advertisement, and the viewer can immediately make a purchase only by pressing the buy button. Such a mechanism can be achieved with ease.

In this way, an information distribution service according to the embodiment involves a distributor, a content holder, a viewer, a sponsor, and also a store, and has a mechanism that allows those to achieve positive results.

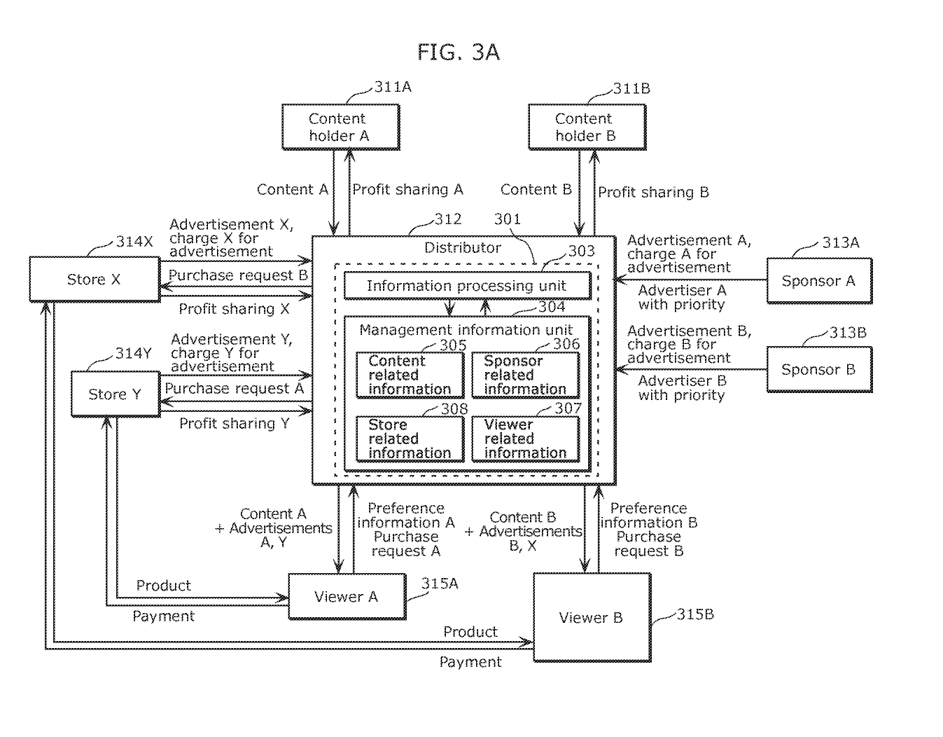

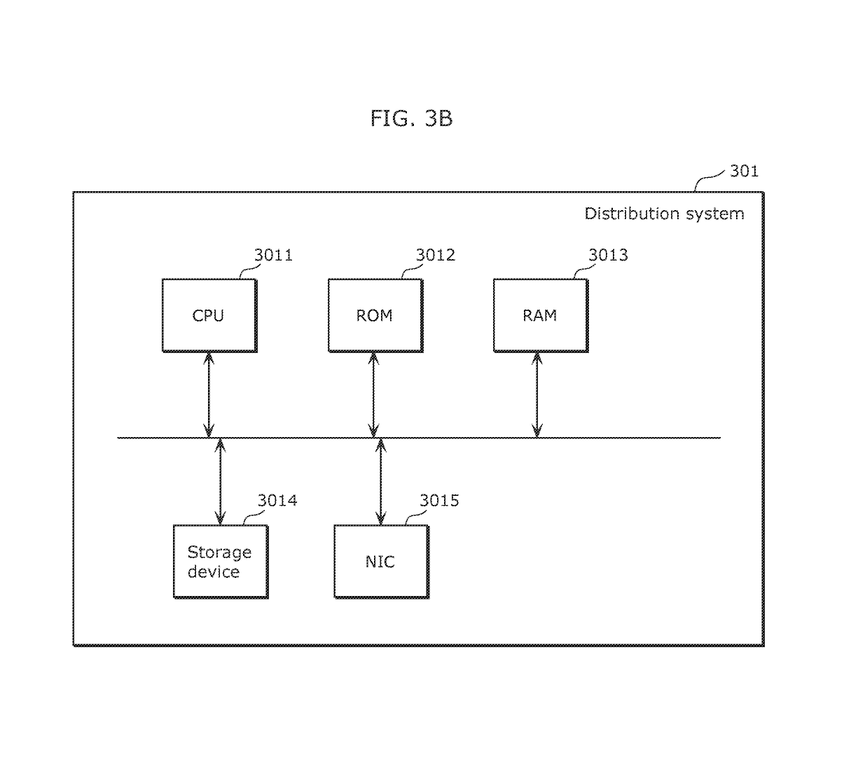

FIG. 3A is a detailed explanatory diagram of a distribution service according to the embodiment. FIG. 3A illustrates in more detail than FIG. 2 the relationship between the structure of a distribution system utilized by this distributor (a cloud-based video distribution server) and stakeholders.

A distribution system 301 includes an information processing unit 303 and a management information unit 304.

The information processing unit 303 accesses various types of information, according to a program executed, and based on the information, performs various types of information processing such as judging conditions; encoding, decoding, encrypting, receiving, and distributing content; reading and writing data from/into the management information unit; and depositing money in and withdrawing money from a designated account.

The management information unit 304 holds (i) content related information 305 which includes content itself received from a content provider, and various types of information associated with the content, (ii) sponsor related information 306 which includes an advertisement itself received from a sponsor, and various types of information associated with the advertisement, (iii) store related information 308 which includes a store advertisement itself received from a store and various types of information associated with the store advertisement, and (iv) viewer related information 307 which includes personal information received from a viewer, and various types of information associated with the personal information.

The distribution system 301 (the information processing unit 303) can distribute, using the information stored in the management information unit 304, content that suits more the viewer's preference, with a more effective advertisement which includes the newest store information, updates the management information unit 304 according to a viewing operation or purchase operation by a viewer, and shares profits with a content holder and a store.

For example, FIG. 3A illustrates a stream of flow as described below. Preference information A of viewer A is stored and managed in the viewer related information 307 in the management information unit 304 through an old viewing history, and when viewer A (315A) views content A provided by content holder A (311A), the distribution system 301 distributes, to viewer A (315A), advertisement A provided by sponsor A (313A) and advertisement Y provided by store Y (314Y) which deals in the advertised product, together with content A. If viewer A (315A) has an interest in the product in advertisement A, and requests for the purchase of the product via advertisement Y from store Y (314Y) (purchase request A), this request is notified to store Y (314Y), and store Y (314Y) sends that product to (the house of) viewer A (315A) in exchange for the payment by viewer A (315A) (automatic payment using a credit card).

FIG. 3B is a hardware configuration of the distribution system 301 according to the embodiment. As illustrated in FIG. 3B, the distribution system 301 includes a central processing unit (CPU) 3011, a read only memory (ROM) 3012, a random access memory (RAM) 3013, a storage device 3014, and a network interface card (NIC) 3015.

The CPU 3011 is a processor which executes a control program stored in the ROM 3012.

The ROM 3012 is a read-only storage area holding a control program and the like.

The RAM 3013 is a volatile storage area used as a work area for when the CPU 3011 executes a control program.

The storage device 3014 is a nonvolatile storage area holding a control program and/or data and the like read or written using the control program.

The NIC 3015 is a communication interface which transmits communication data to a network or receives communication data from the network. It should be noted that the network which the NIC 3015 connects may be a wire LAN conforming to, for instance, the IEEE802.3 standard or a wireless LAN conforming to, for instance, the IEEE802.11a/b/g/n standard. In addition, the above network includes communication networks of any type such as a network, a metro network, a network in a company, and a home network, including a public telephone line, a mobile phone line, a satellite communication line, and a data telecommunication line.

The information processing unit 303 and the management information unit 304 in FIG. 3A are achieved by the CPU 3011, the ROM 3012, the RAM 3013, the storage device 3014, the NIC 3015, and the like.

Now, the following describes various types of information managed by the management information unit 304.

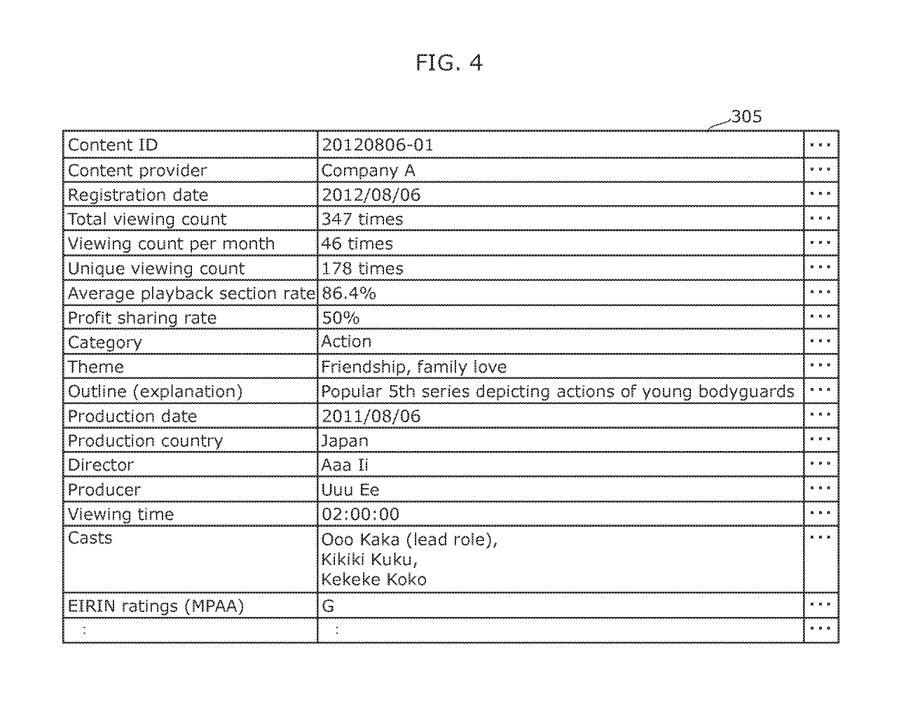

FIG. 4 illustrates an example of content related information in the distribution system. FIG. 4 illustrates an example of content associated information of the content related information 305.

Content ID is a unique identification number assigned to this content. A registration date is the date when the content is registered in the distribution system. A total viewing count is the number of times the content has been played. A viewing count per month is the number of times the content has been played in this month. A unique viewing count is the number of viewers who has viewed the content at least once. An average playback section rate indicates an average percentage of a section that is played (and also fast-forwarded, for instance) in the whole content while the content is viewed once. A profit sharing rate indicates what percentage of the whole profits produced by viewing the content is returned to a content holder. A theme is a theme of this content.

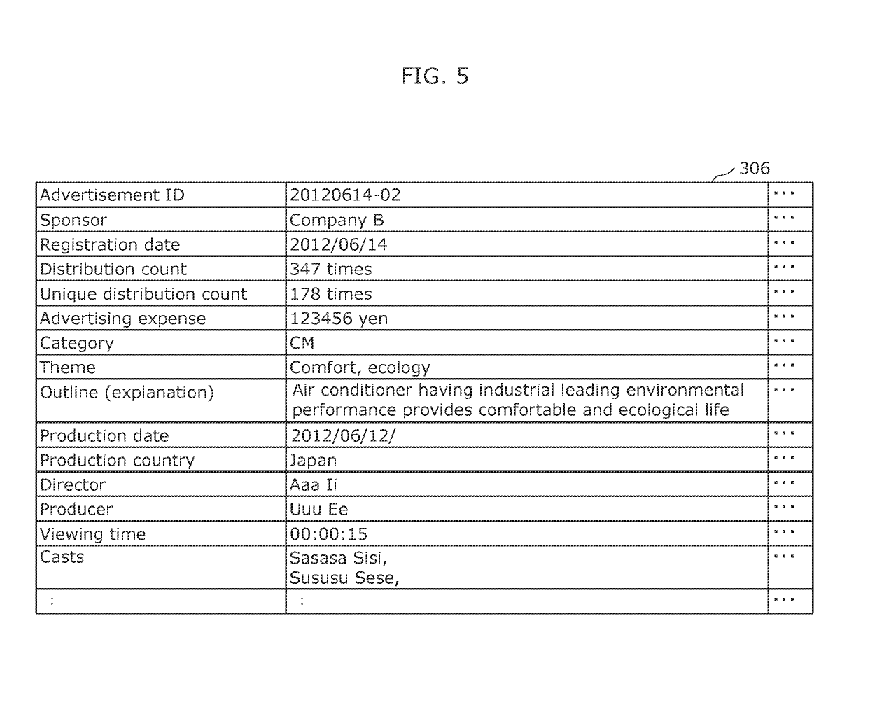

FIG. 5 illustrates an example of sponsor related information in the management information unit of the distribution system. FIG. 5 illustrates an example of advertisement associated information of the sponsor related information 306.

An advertisement ID is a unique identification number assigned to this advertisement. A registration date is the date when the advertisement is registered in the distribution system. A distribution count is the total number of times the advertisement is distributed so far. A unique distribution count is the number of viewers to whom the advertisement has been distributed at least once. An advertising expense is an amount of money that the sponsor has paid to the distributor, for the distribution of this advertisement. A theme is a theme of this advertisement.

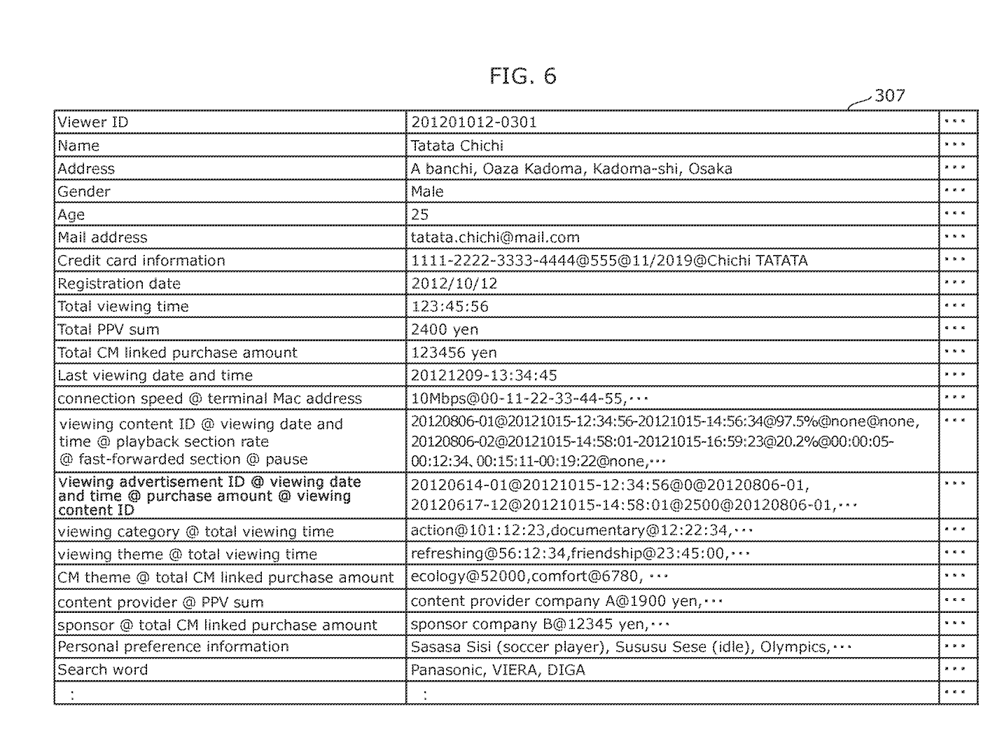

FIG. 6 illustrates an example of viewer related information in the distribution system. FIG. 6 illustrates an example of the viewer related information 307.

A viewer ID is a unique identification number assigned to this viewer. A registration date is the date when the viewer is registered in the distribution service. A total viewing time is a total time for which this viewer has viewed content using this distribution system. A total pay per view (PPV) sum is a total amount of money paid by this viewer for viewing pay-content using this distribution system. A total CM linked purchase amount is a total amount of money paid by this viewer via a commercial message (CM) provided by this distribution system. A last viewing date and time is the date and time when this distribution system is utilized last. Connection speed @ terminal Mac address is a bit rate at which a viewing terminal of this viewer (identified using a Mac address) was able to receive content last time. Viewing content ID @ viewing date and time @ playback section rate @ fast-forwarded section @ pause is information including a content ID of viewed content in a viewing history of the viewer, (start and end) dates and times thereof, a proportion of a playback section (fast-forwarded and rewound portions may also be included), and a portion at which a pause is made. Viewing advertisement ID @ viewing date and time @ purchase amount @ viewing content ID is information which includes an ID of a viewed advertisement, a date and a time at which the advertisement starts, a price of a product purchased due to the advertisement, and an ID of content viewed with the advertisement. Viewing category @ total viewing time is information which includes the category and a total time of content that this viewer has viewed. Viewing theme @ total viewing time is information which includes the theme and a total time of content that this viewer has viewed. CM theme @ total CM linked purchase amount is a total amount of the product(s) (service(s)) that this viewer has purchased due to advertisement for each advertising theme. Content provider @ PPV sum is an amount of total proceeds of pay content for each content provider. Sponsor @ total CM linked purchase amount is an amount of total proceeds of product(s) (service(s)) that this viewer has purchased due to advertisement for each advertisement sponsor. Personal preference information is a preference information keyword of this viewer obtained directly or indirectly from a viewing history or the like. A search word is a keyword used when this viewer makes a search on an advertisement screen or a store advertisement screen, and the like.

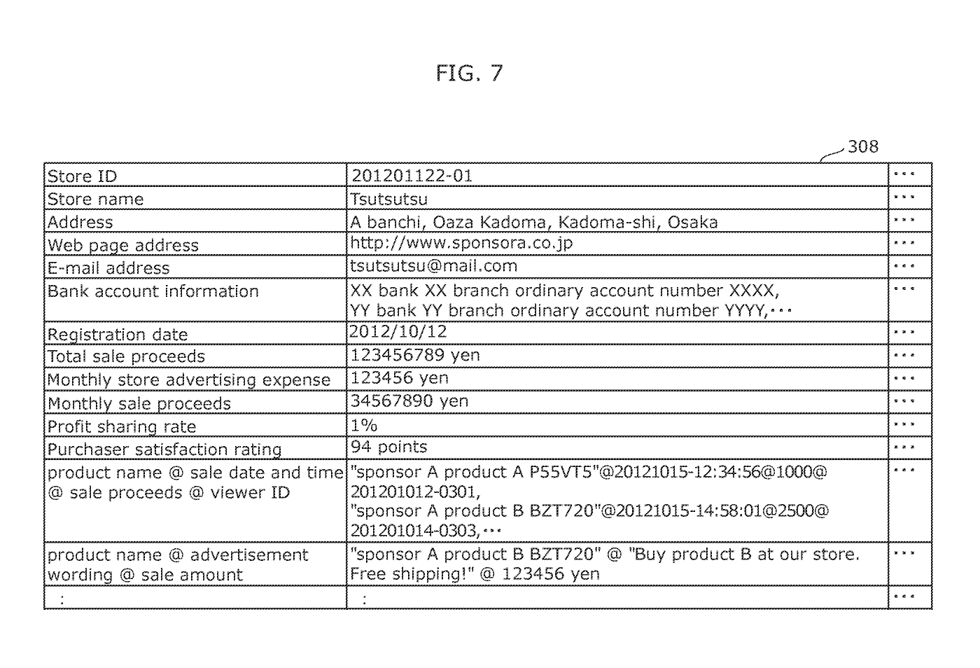

FIG. 7 illustrates an example of store related information of a distribution system. FIG. 7 illustrates an example of store associated information of the store related information 308.

A store ID is a unique identification number assigned to this store. A registration date is the date when the store is registered into the distribution system. Total sale proceeds indicate a total amount of sales of this store obtained via this distribution system. A monthly store advertising expense is an advertising expense for this month paid by this store to a distributor for having an advertisement of the store displayed. Monthly sale proceeds indicate a total amount of sales in this month of this store obtained via this distribution system. A profit sharing rate is a percentage of the sum of money distributed to a distributor when this store gains profits via this distribution system. A purchaser satisfaction rating is a satisfaction rating for this store of the viewer who has made a purchase via this distribution system. Product name @ sales date and time @ sale proceeds @ viewer ID is information which includes the name of a product, date and time when the product is sold, a price of the product when sold, and a viewer ID of the viewer who has purchased the product. Product name @ advertisement wording sales amount is information which includes the name of a product, a sales wording of this store for that product, and a price of the product.

Such information is managed by the management information unit 304, which allows a distribution system to distribute, to viewers, more interesting content together with a more interesting sponsor advertisement which includes store information that allows smooth selling (for example, a buy button for immediately deciding to buy a product on sale).

Next is a description of a typical processing flow by the information processing unit of the distribution system.

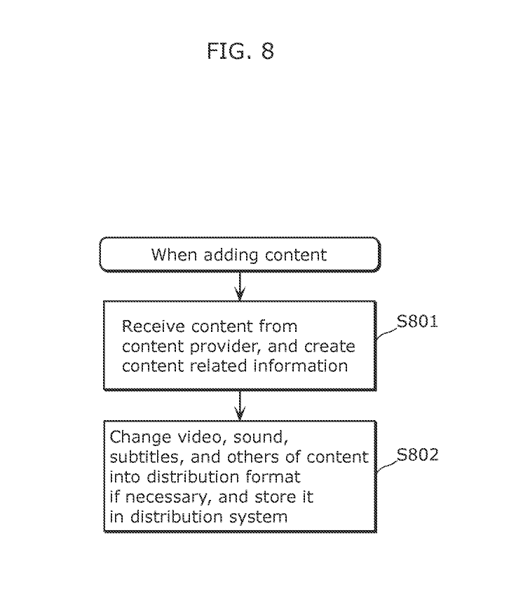

FIG. 8 illustrates an example of a workflow when adding content. FIG. 8 illustrates a workflow when adding content, in the distribution system 301.

First, a distributor 312 (the distribution system 301) receives content from a content provider, and creates the above content related information 305 (step S801).

The information processing unit 303 of the distribution system 301 changes the received content into a distribution format if necessary, and stores the content into the management information unit of the distribution system (step S802).

It should be noted that a common technical basis is being made which allows optimal streaming to be performed at a low cost according to various terminals and used lines such as dynamic adaptive streaming over HTTP (DASH). When such a technical basis is used, the distribution system may previously create, for example, plural distribution formats (data of distribution streams) that meet coding conditions that differ in resolution or bit rate, and select the one to be distributed out of the created distribution streams, according to “connection speed @ terminal Mac address”.

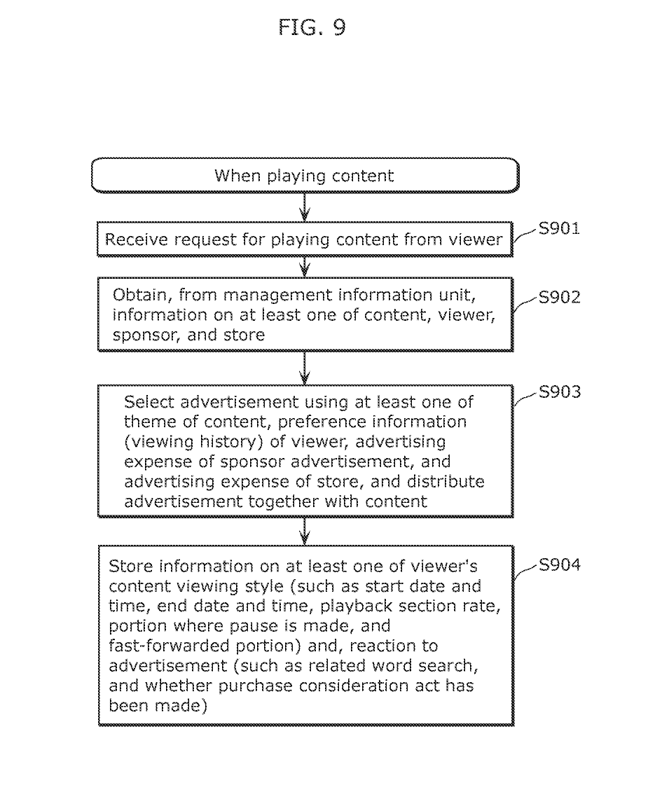

FIG. 9 illustrates an example of a workflow when playing content. FIG. 9 illustrates a workflow for when playing content in the distribution system 301.

First, the distribution system 301 receives a request for playing certain content from a viewer (step S901).

The distribution system 301 obtains information on at least one of the content related information 305, the viewer related information 307, the sponsor related information 306, and the store related information 308 stored in the management information unit 304 (step S902).

Next, using at least one of the theme of content to be played, preference information (viewing history) of a viewer, an advertising expense of a sponsor advertisement, and an advertising expense of a store (monthly store advertising expense), the distribution system 301 selects a sponsor advertisement or a store advertisement (or both) to be distributed, and distributes the advertisement(s) together with content (step S903).

Upon the end of the viewer viewing content, the distribution system 301 stores information on at least one of a viewer's content view style (such as start date and time, end date and time, a playback section rate, a portion where a pause is made, and a fast-forwarded portion) and reactions to an advertisement (such as related word search, and whether a purchase consideration act has been made), into the management information unit 304 (step S904).

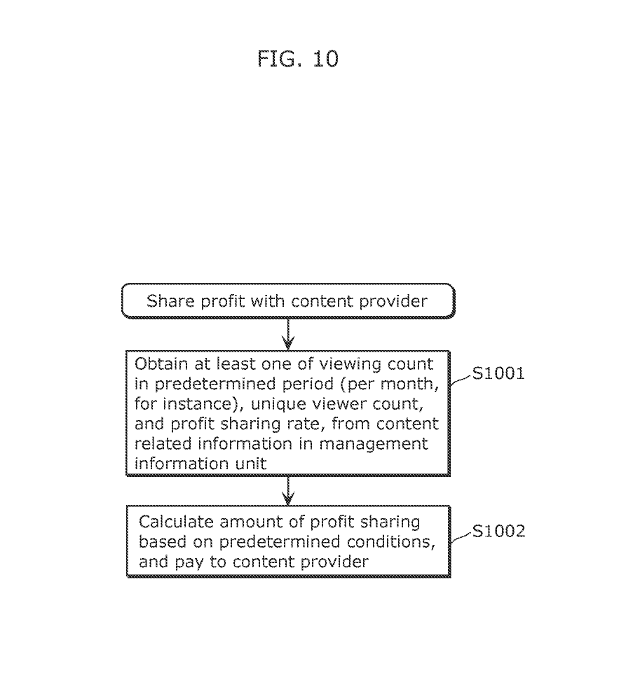

FIG. 10 illustrates an example of a workflow of profits sharing. FIG. 10 illustrates a workflow when sharing profits between a content provider and a distributor.

The distribution system 301 obtains at least one of a viewing count in a predetermined period (viewing count per month), a unique viewing count, and a profit sharing rate, from the content related information in the management information unit 304 (step S1001).

The distribution system 301 calculates the amount of profit sharing based on predetermined conditions, and pays to a designated account of a content provider (specified in content related information, but omitted in FIG. 4) (step S1002).

It should be noted that profits may be shared only when a viewing count per month is greater than or equal to a predetermined number of times, or an amount of profit to be shared may be reduced or profits may not be shared if an average playback section rate is lower than a predetermined value. Specifically, the information processing unit 303 (program) of the distribution system 301 automatically performs calculation or a process to make the above determination, based on a contract between a content provider and a distributor.

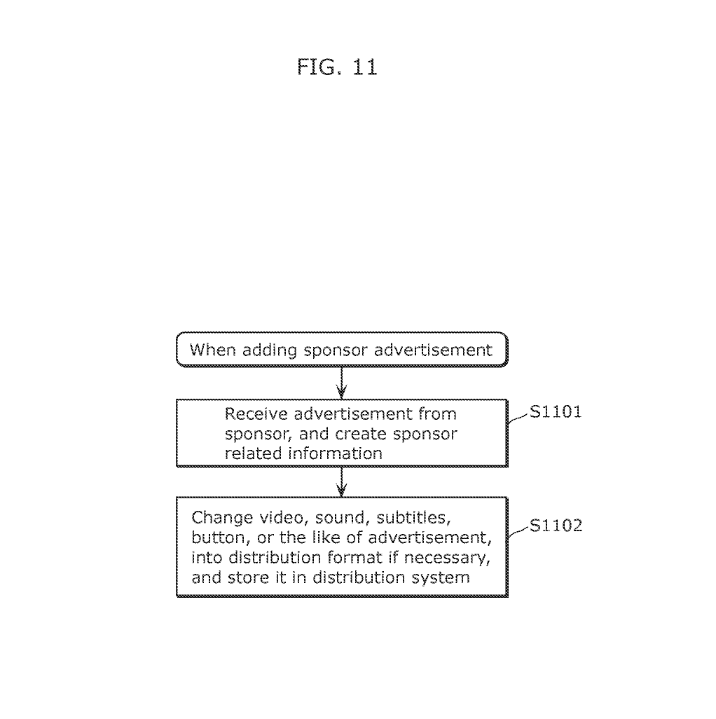

FIG. 11 illustrates an example of a workflow when adding a sponsor advertisement. FIG. 11 illustrates a workflow for when adding a sponsor advertisement. The distributor 312 receives an advertisement from a sponsor, and creates sponsor related information associated therewith (step S1101).

Next, a video, a sound, subtitles, or a button of an advertisement is changed into a distribution format if necessary, and the resultant data is stored in the distribution system 301 (step S1102).

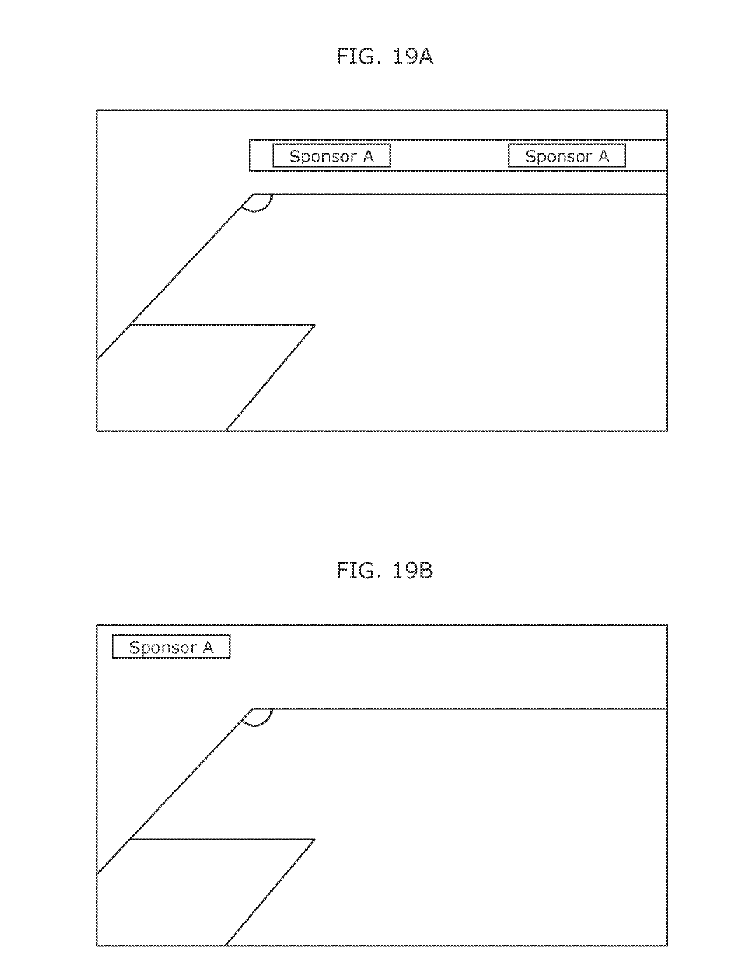

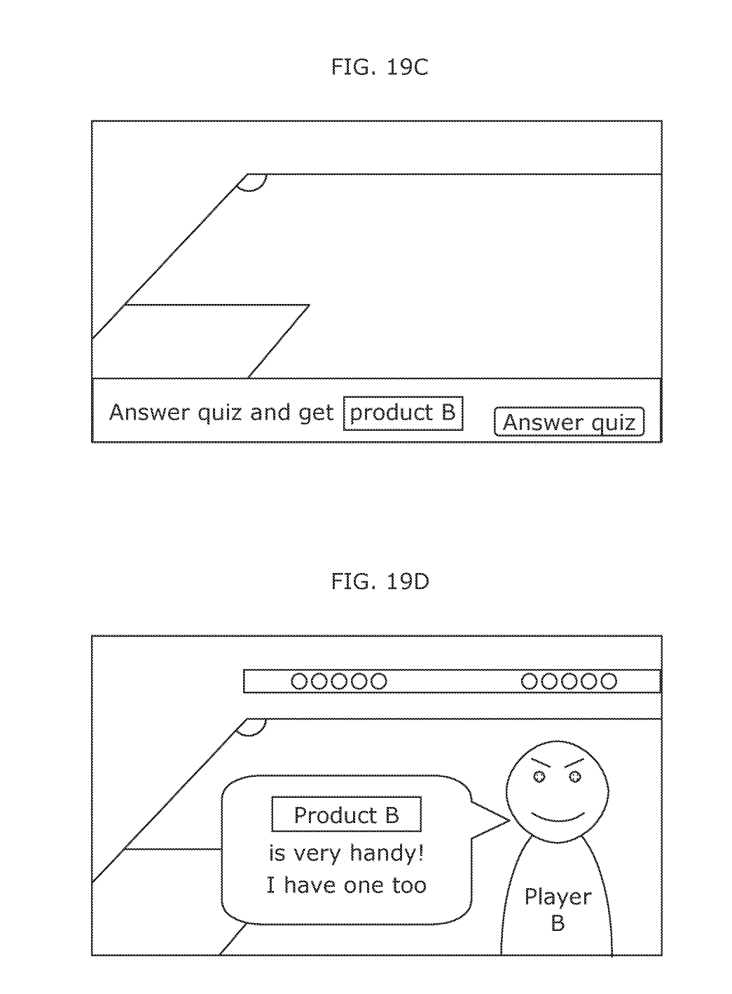

For example, advertisement information is submitted in at least one of video, still image, and sound formats, or described in a browser display format such as HTML5. In addition, it may be conceived that what advertisement display style is allowed differs for each advertisement as shown in FIGS. 19A to 19D later, and a submit format and a display format may be described in sponsor related information. Such information is omitted in FIG. 5.

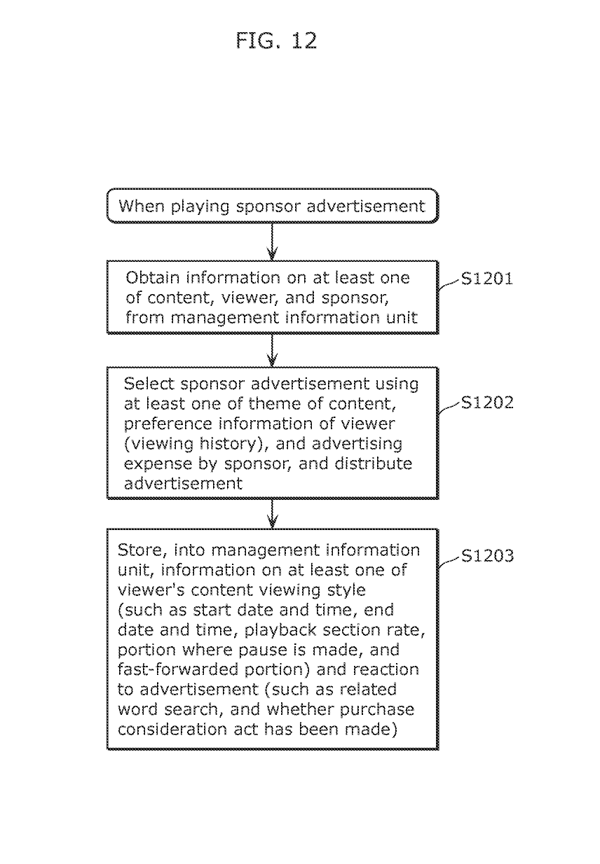

FIG. 12 illustrates an example of a workflow for when playing a sponsor advertisement. FIG. 12 illustrates a workflow for when playing a sponsor advertisement.

First, the distribution system 301 obtains information on at least one of content related information, viewer related information, and sponsor related information, from the management information unit 304 (step S1201).

The distribution system 301 selects or determines a sponsor advertisement using at least one of a theme of content, preference information of a viewer (viewing history), and an advertising expense for a sponsor advertisement, and distributes the selected advertisement (step S1202).

Upon the end of the viewer viewing content, the distribution system 301 stores, into the management information unit 304, information on at least one of a viewer's content view style (such as start date and time, end date and time, a playback section rate, a portion where a pause is made, and a fast-forwarded portion) and reactions to an advertisement (such as related word search, and whether a purchase consideration act has been made) (step S1203).

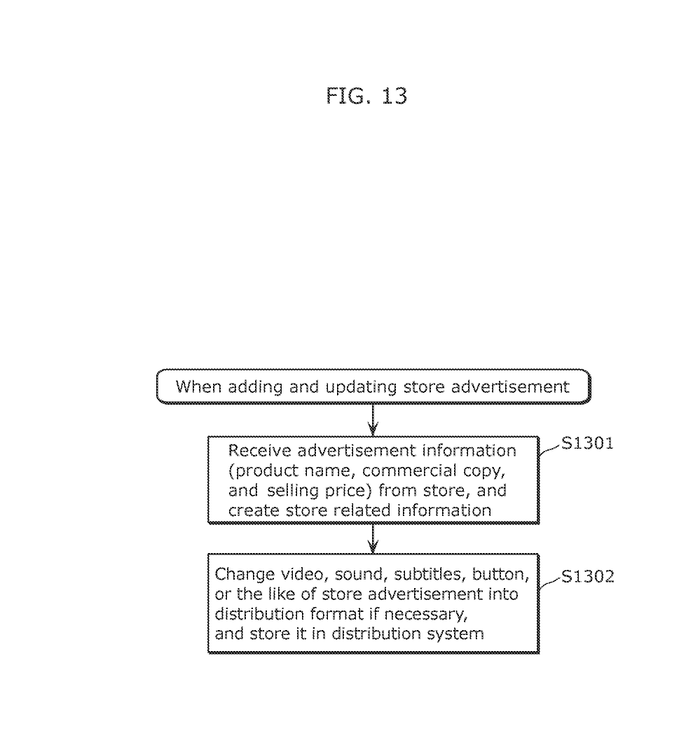

FIG. 13 illustrates an example of a workflow for when adding and updating a store advertisement. FIG. 13 illustrates a workflow for when adding and updating a store advertisement.

The distributor 312 receives advertisement information (a product name, a commercial copy, and a selling price) from a store (314X or 314Y), and creates store related information (step S1301).

Next, a video, a sound, subtitles, or a button of an advertisement is changed into a distribution format if necessary, and thereafter the resultant data is stored in the distribution system (step S1302).

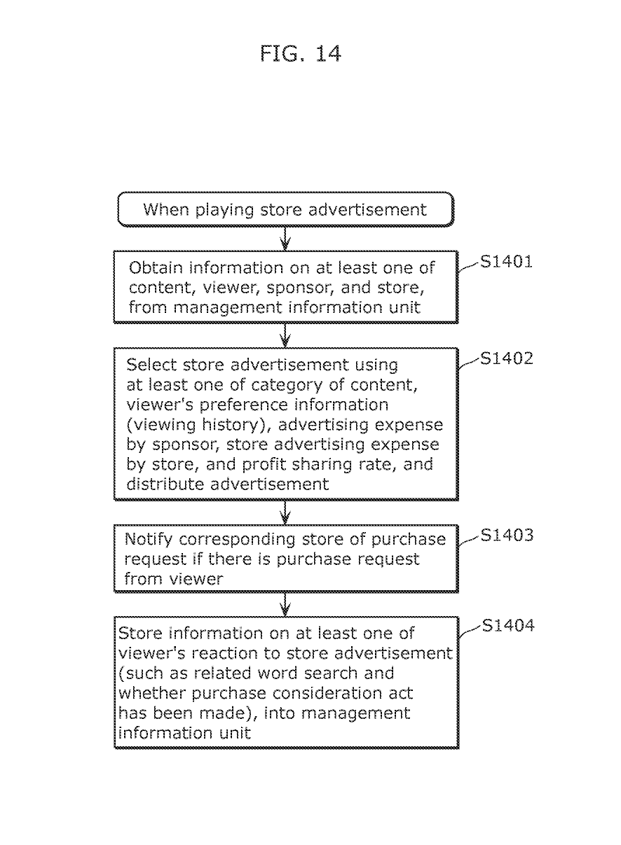

FIG. 14 illustrates an example of a workflow for when playing a store advertisement. FIG. 14 illustrates a workflow for when playing a store advertisement.

First, the distribution system 301 obtains information on at least one of content related information, viewer related information, sponsor related information, and store related information, from the management information unit 304 (step S1401).

Next, the distribution system 301 selects and determines a store advertisement using at least one of the category of content, viewer's preference information (viewing history), an advertising expense for a sponsor advertisement, a store advertising expense (monthly store advertising expense) of a store, and a profit sharing rate, and distributes the advertisement (step S1402).

In step S1402, if there is a purchase request from a viewer, the distribution system 301 notifies the corresponding store of the purchase request (step S1403).

Then, the distribution system 301 stores information on at least one of the viewer's reactions to a store advertisement (such as whether a purchase consideration act has been made, related word search, and a time spent to decide to make a purchase) into the management information unit 304, after the viewer ends viewing the advertisement (step S1404).

It should be noted that although here, a description is given of as a part of a workflow, when there is a purchase request from a viewer, the information processing unit 303 of the distribution system 301 notifying a store of the request, the present invention is not limited to this.

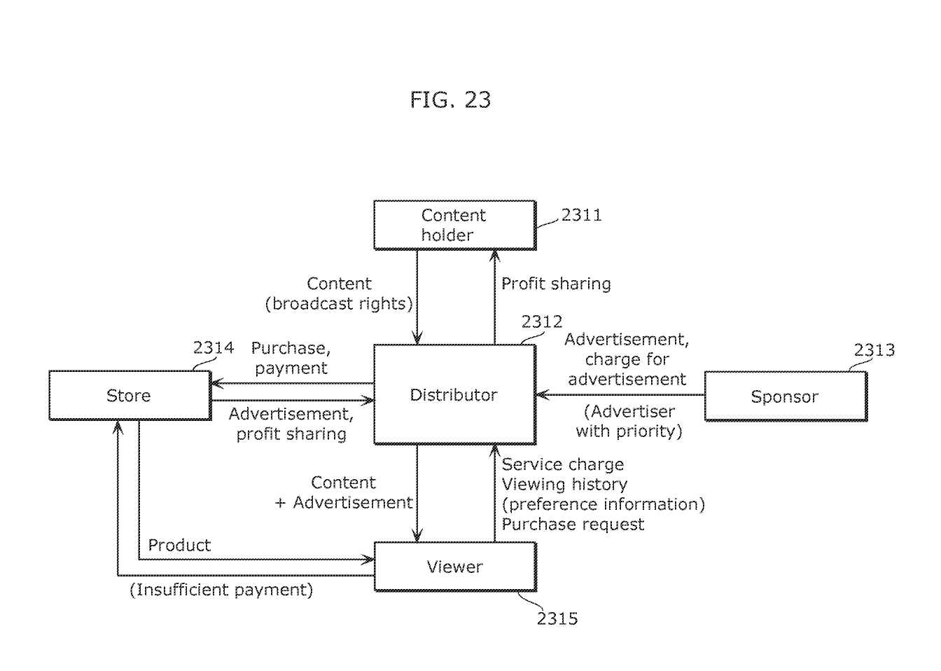

For example, as illustrated in FIG. 23, one possible service format is that if a service fee (such as a monthly fixed fee) is charged from a viewer, an amount of money that can be spent to purchase a product/service is set within the fee. In such a case, upon receipt of a purchase request from a viewer, the distributor 312 (the distribution system 301) may notify the store of the purchase request unless the set amount is exceeded. Furthermore, if the amount of money is not sufficient, the store or the distributor charges the viewer for the shortage or may notify the viewer that he/she cannot make a purchase if there is not enough money left

Such a mechanism is embedded in a program of the information processing unit 303, which achieves an advantage of allowing a viewer to enjoy freely making a purchase within a range which does not exceed a previously set amount even when the viewer does not have a credit card because of the viewer's age, for instance.

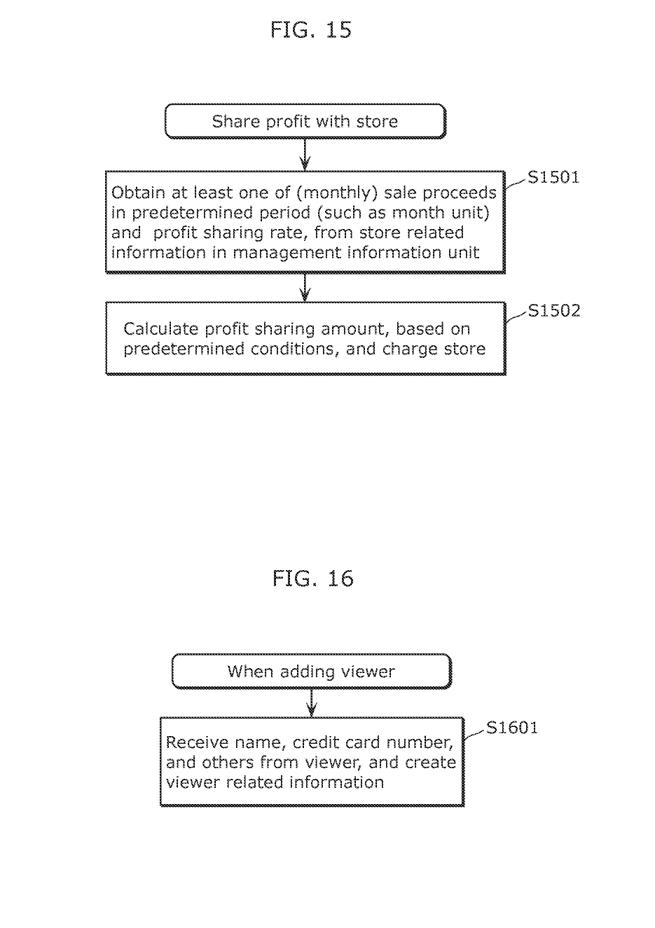

FIG. 15 illustrates an example of a workflow of sharing profits between a distributor and a store. FIG. 15 illustrates a flow for when a store and a distributor share profits.

First, the distribution system 301 obtains at least one of sale proceeds (monthly sale proceeds) in a predetermined period and a profit sharing rate from the store related information in the management information unit 304 (step S1501).

Next, the distribution system 301 calculates the amount of profits to be shared, based on predetermined conditions, and charges from the designated account of a store (step S1502).

It should be noted that the distribution system 301 may not advertise a store at all if the purchaser satisfaction rating of that store is lower than a predetermined value. Such a determination is made by, specifically, the information processing unit (program) of the distribution system automatically performing calculation and a process, based on a contract between a store and a distributor.

FIG. 16 illustrates an example of a workflow used when adding a viewer. FIG. 16 illustrates a process performed when adding a viewer.

The distribution system 301 receives personal information such as a name and a credit card number and preference information from a viewer, and creates viewer related information (step S1601).

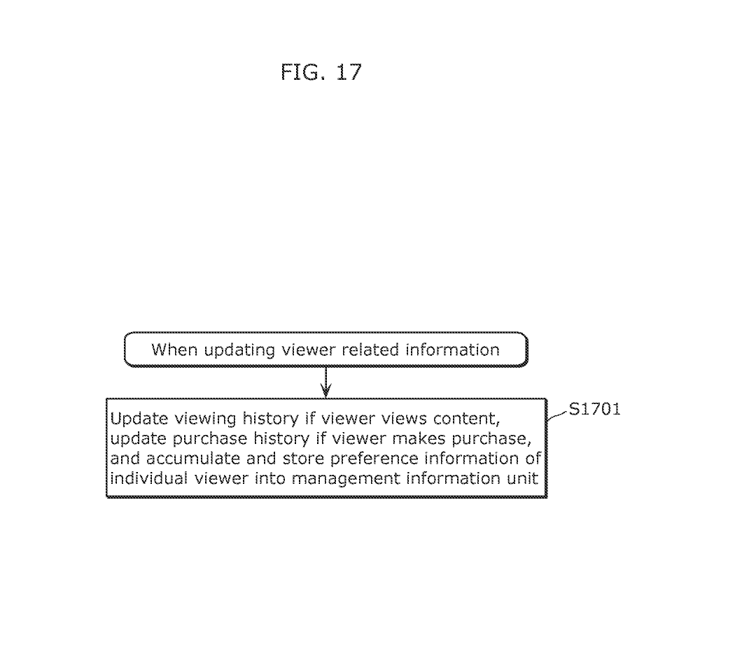

FIG. 17 illustrates an example of a workflow for when updating a viewer. FIG. 17 illustrates a process performed when updating viewer related information.

The distribution system 301 updates a viewing history of a viewer if the viewer views something, updates his/her purchase history if the viewer purchases something, and thereby accumulates and stores preference information of each individual viewer into the management information unit 304 (step S1701).

The information processing unit 303 records on and accumulates in the viewer related information 307, a viewing history and operation of a viewer each time the viewer utilizes a distribution system. As a result, the viewer related information 307 can be used as personal preference information with high-precision, which provides viewers with more comfortable viewing and operating environment.

For example, if the distribution system 301 has learned from the viewing history that the viewer mostly views comedy shows on Friday night, the distribution system 301 can recommend the viewer to view such comedy shows on Friday night. In addition, if the distribution system 301 has learned from the viewing history in the past that the viewer often stops viewing content if an advertisement is provided while viewing the content, the distribution system 301 can preferentially provide an advertisement in an advertisement display mode according to which an advertisement is displayed in small size on the corner of the screen, rather than in an advertisement display mode according to which an advertisement occupies the screen for a predetermined time period, and thus various applications are possible according to viewers.

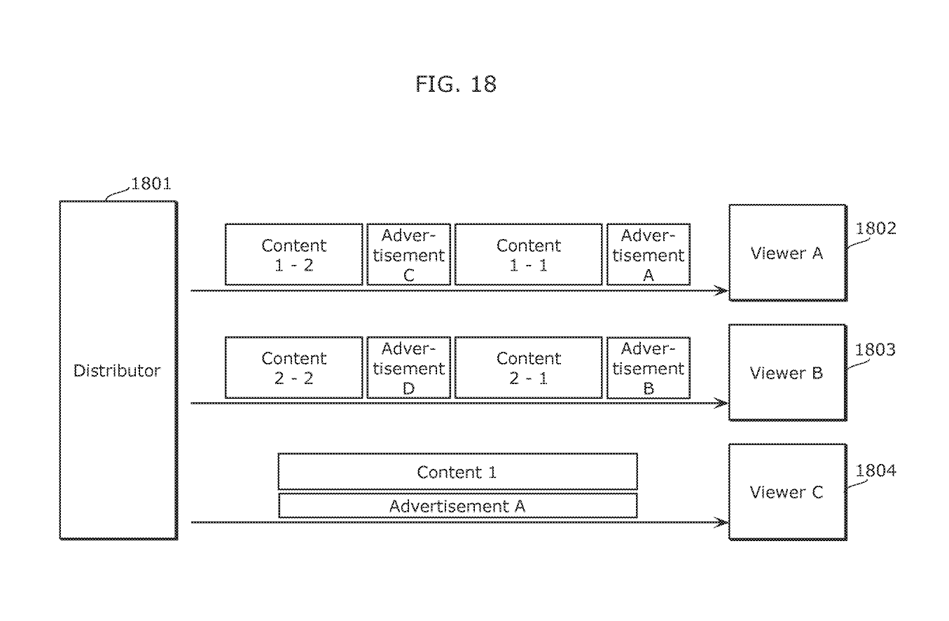

FIG. 18 is an explanatory diagram of an advertisement display mode according to a viewer. FIG. 18 illustrates an example of an advertisement display mode for when distributing content 1 and 2 based on preference information of viewer related information.

First is a description of the case where viewer A selects to view content 1.

When content 1 selected by viewer A for viewing is distributed, the information processing unit 303 advances distribution processing in the following order: advertisement A; content 1-1 (the first half of content 1); advertisement C; and content 1-2 (the latter half of content 1). Advertisements A and C are selected as a result of having processed information as to which advertisement is to be distributed based on information in the management information unit 304 as described above using FIGS. 12 and 14.

Next is a description of the case where viewer B selects to view content 2.

When distributing content 2 to viewer B, the information processing unit 303 advances distribution processing in the following order: advertisement B; content 2-1 (the first half of content 2); advertisement D; and content 2-2 (the latter half of content 2).

Next is a description of the case where viewer C has selected to view content 1. Here, it is assumed that viewer C is a viewer who does not prefer a display mode according to which an advertisement occupies a screen.

In this case, advertisement A selected by the information processing unit 303 is superimposed and displayed on a portion of content 1 for the whole or partial time period in which content 1 is played.

FIGS. 19A to 19D illustrate first to fourth examples of advertisement display. FIGS. 19A to 19D illustrate examples of advertisement display in which a sponsor advertisement is superimposed on content being played, as an example for viewer C in FIG. 18. Specifically, possible examples when soccer game content is distributed are that: a sponsor advertisement is superimposed aside a soccer field (FIG. 19A); a sponsor advertisement is superimposed on the corner of a screen (FIG. 19B); a sponsor advertisement is superimposed on a part of the screen (bottom edge) (FIG. 19C); and video information or sound information in which the viewer's favorite soccer player (player B) advertises a sponsor's product is superimposed (FIG. 19D). The information processing unit 303 of the distribution system 301 entirely performs such processing of superimposing images and sounds so that different videos (in different advertisement display modes) are distributed to viewers in order to utilize a sponsor advertisement most effectively.

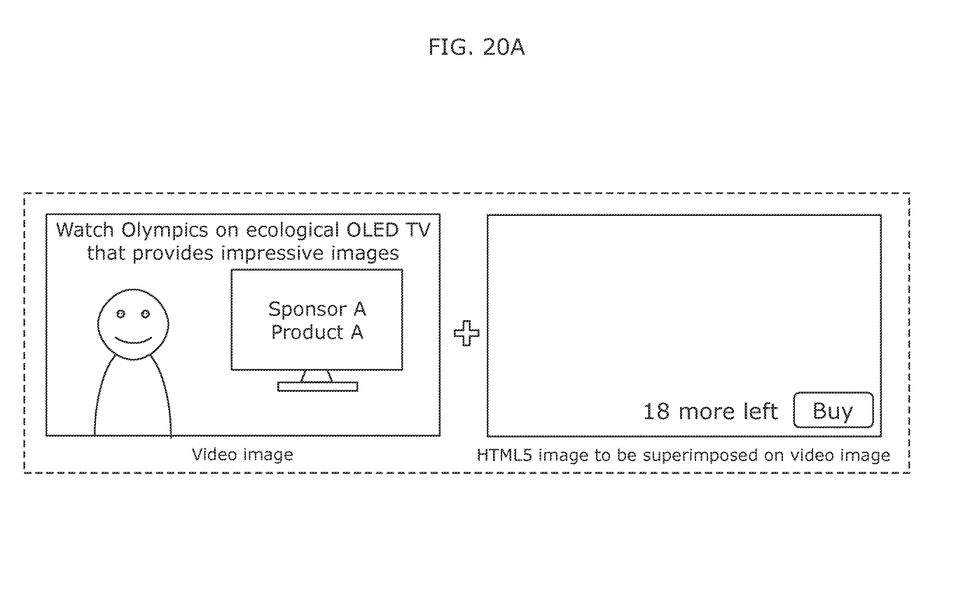

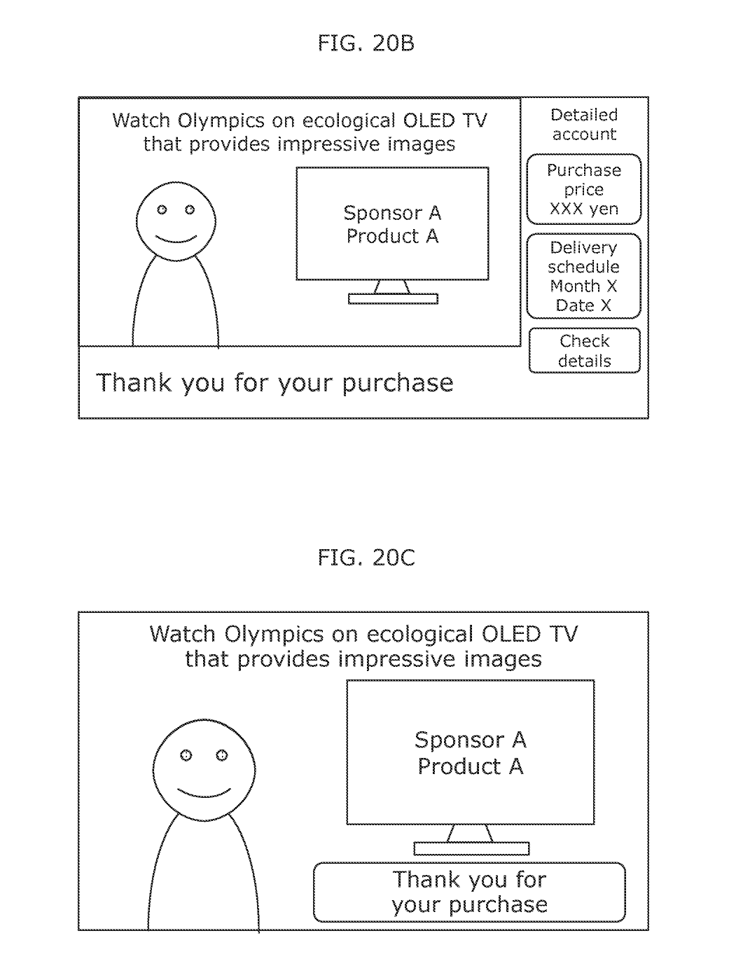

FIGS. 20A to 20C illustrate first to third examples of superimposed advertisements. FIGS. 20A to 20C illustrate examples in which store advertisements described in HTML5 are superimposed on video picture content.

In FIG. 20A, a video picture of content itself is shown on the left, and a video of a store advertisement described in HTML5 to be superimposed on the video picture is shown on the right. Both of these are separately distributed to a viewer, and combined and displayed on a viewer terminal on the viewer side. Using such a mechanism, a store advertisement may be distributed in which the quantity of stock of the product is displayed in real time, or the “Buy” button is provided to prompt a viewer to immediately decide to purchase the product in a short advertisement display period.

FIGS. 20B and 20C illustrate examples of a confirmation screen displayed when a viewer presses the “Buy” button and requests for the purchase. When content (sponsor advertisements in FIGS. 20B and 20C) and a store advertisement are both described in HTML5 and distributed, it is easy to enlarge and reduce a video in size. Thus, the standard function of an HTML5 browser achieves with ease the display as illustrated in FIG. 20B by the information processing unit 303 performing the above display control.

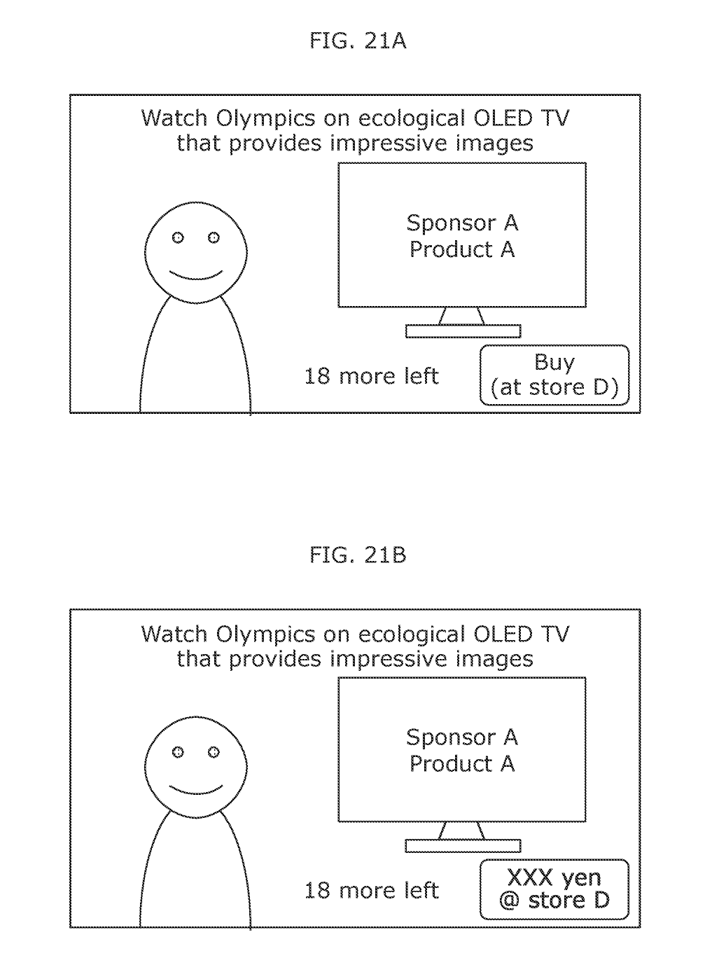

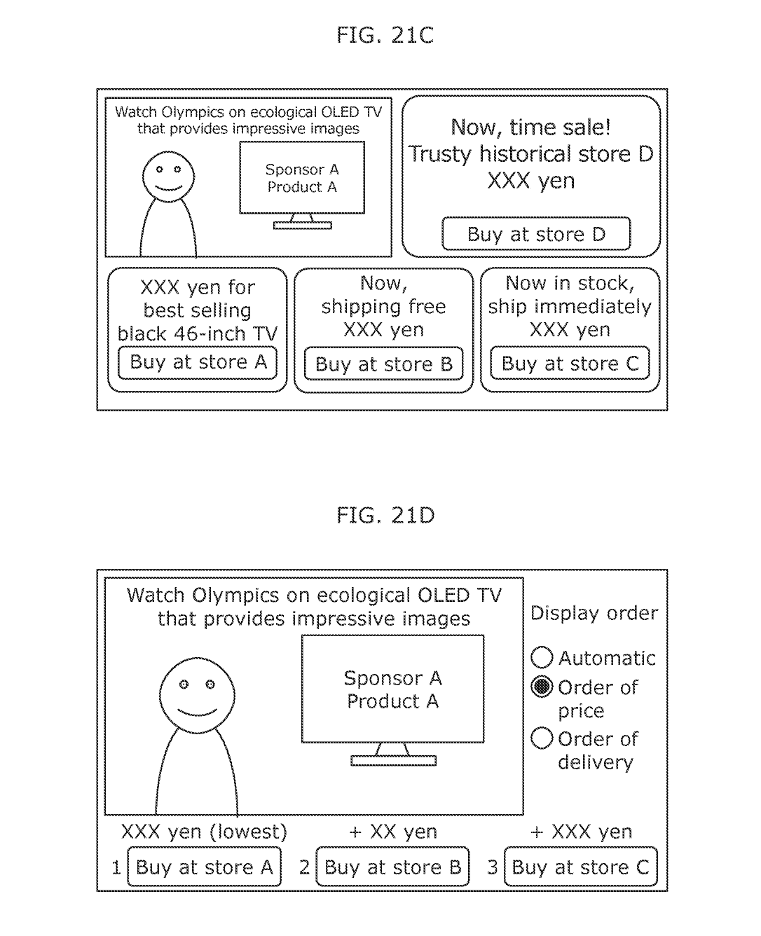

FIGS. 21A to 21D illustrate first to fourth examples of an advertisement preferential display. FIGS. 21A to 21D illustrate examples of selecting a store advertisement. Which store is to be advertised is determined through a workflow described using FIG. 14. For example, a store advertisement may be superimposed so that a store whose profit sharing rate is the highest can be easily selected by a viewer by default, based on store related information. FIGS. 21A and 21B illustrate examples of advertisement display in the above case. The information processing unit performs processing of advertising only store D whose profit sharing rate is the highest, without showing, to a viewer, stores other than the store whose profit sharing rate is the highest.

FIG. 21C illustrates an example in which for example, an advertisement of store D whose profit sharing rate is the highest is displayed so as to be most prominent, and advertisements of stores A, B, and C are displayed whose profit sharing rate is the second highest.

FIG. 21D illustrates an example in which the order of priority of stores to be displayed is selected by a viewer and store information is listed according to the order.

It should be noted that if a distribution format is HTML5 based, a display mode according to the status can be achieved with ease while freely changing the layout of content and advertisements.

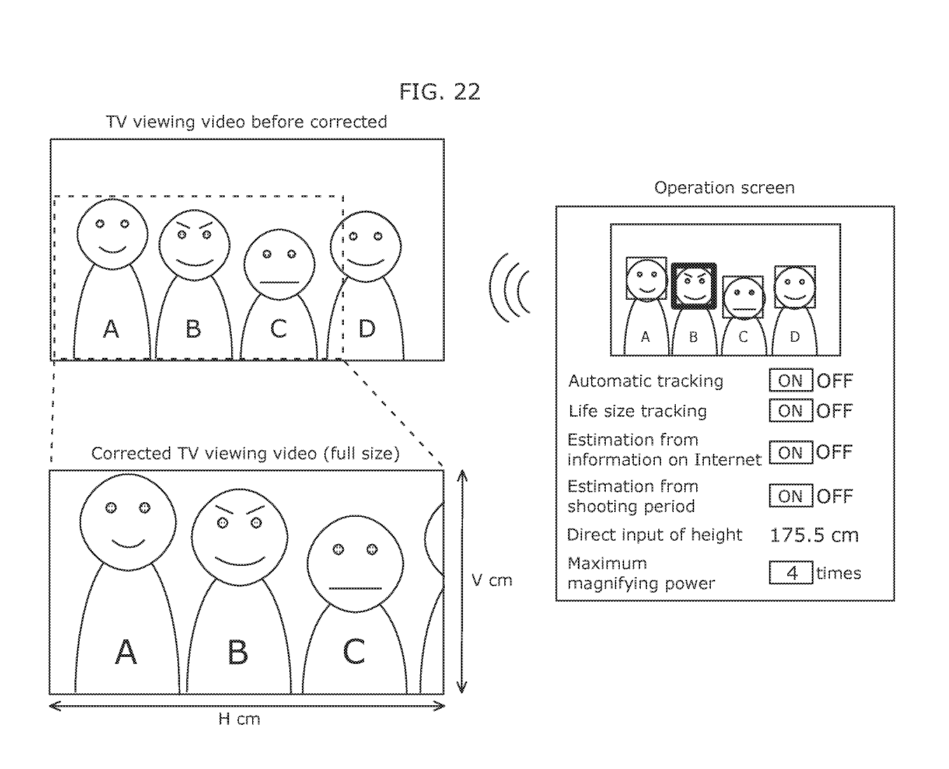

FIG. 22 is an explanatory diagram of operation of tracking persons for playback in life-size. FIG. 22 illustrates an example of a viewing method using person recognition. For example, if a viewer desires to continue viewing person B in FIG. 22, person B whose face has been recognized may be selected on the operation screen of a viewer terminal, and automatic tracking may be turned ON which indicates automatically tracking and displaying person B as long as person B is included in a video. In addition, life-size tracking may be turned ON if a viewer desires to view person B in life size on the viewer's TV. In this case, the size of the face of person B from height information and a full-length photograph of person B may be obtained from the server on the Internet, determine taking into consideration the time when the photograph is taken, or prompt a viewer to directly input, or such information may be previously distributed from a distribution system. The above allows the face to be enlarged in life size even if only the face appears on the screen. It should be noted that the actual screen size of a TV may be obtained via HTML5 or previously set by a viewer through initial setting or the like, for example. The largest enlargement ratio indicates how much person B is allowed to be enlarged when person B appears in small size in an original video. A function of setting the largest enlargement ratio is provided in order to avoid a displayed video from being rough due to an increase in the enlargement ratio.

Such functions of extracting and enlarging a specific region may be performed at the viewer terminal on the viewer side, and the distribution system may be requested to set such settings, and distribute a video enlarged by transcoding in real time.

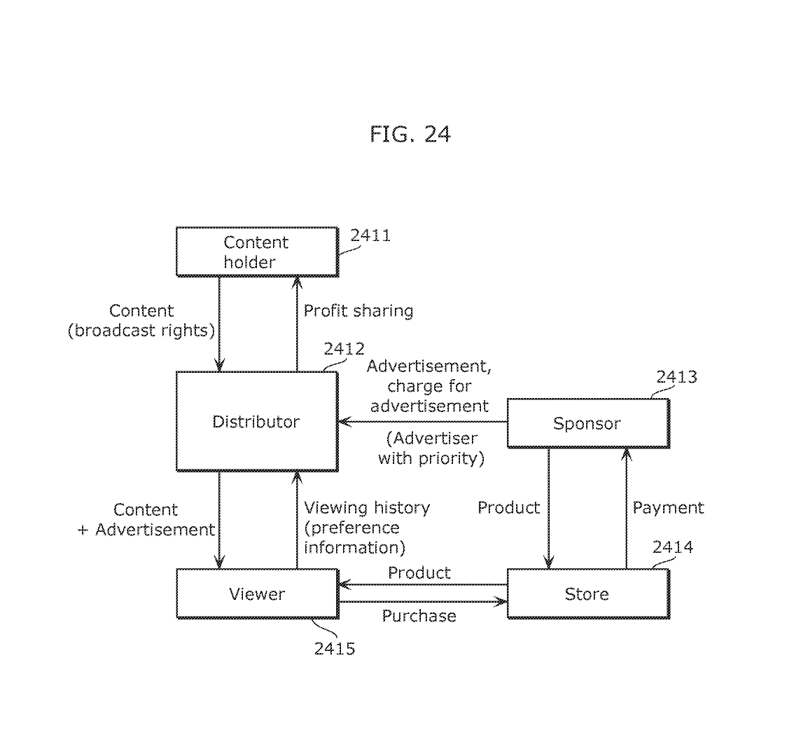

FIG. 24 is an explanatory diagram of a distribution service according to the present embodiment. FIG. 24 illustrates an overview of a distribution service in the case of distributing an advertisement by a sponsor designating a store which sells a product. A store which provides a product and a service informed via a sponsor advertisement may not only be necessarily recommended from a distributor, but also designated by a sponsor,

### Variation of Embodiment

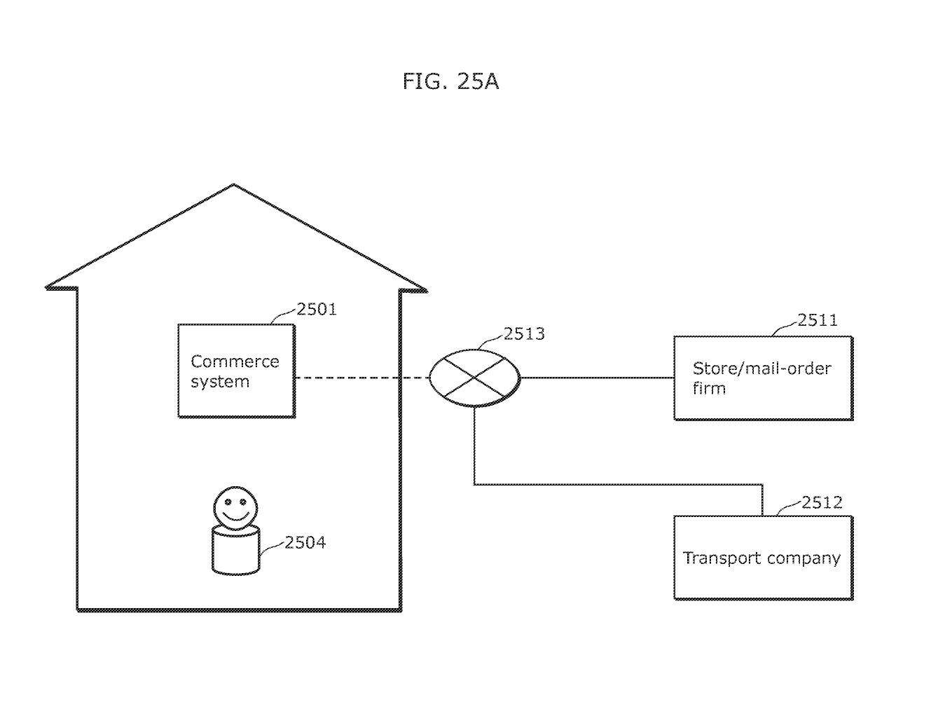

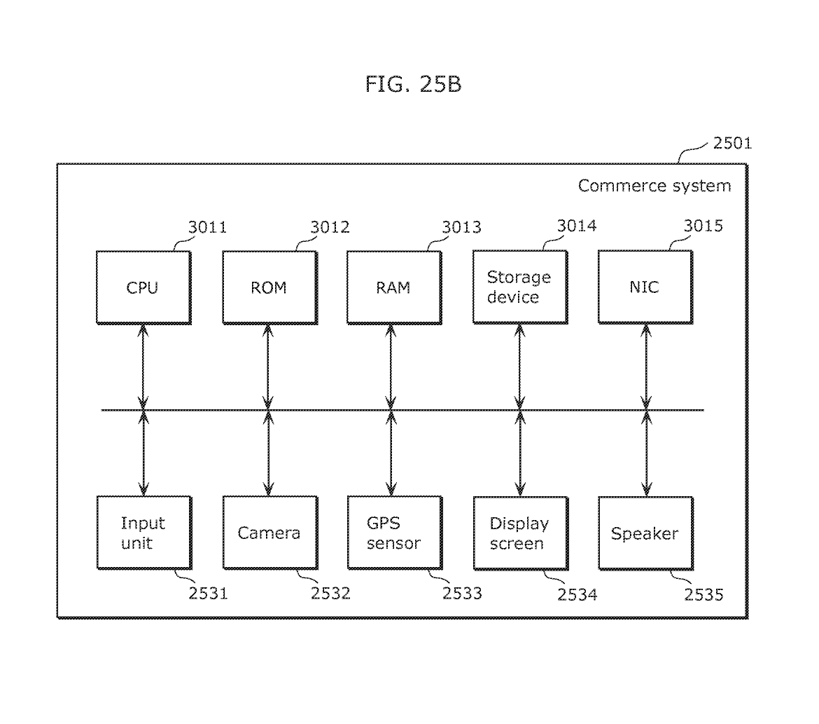

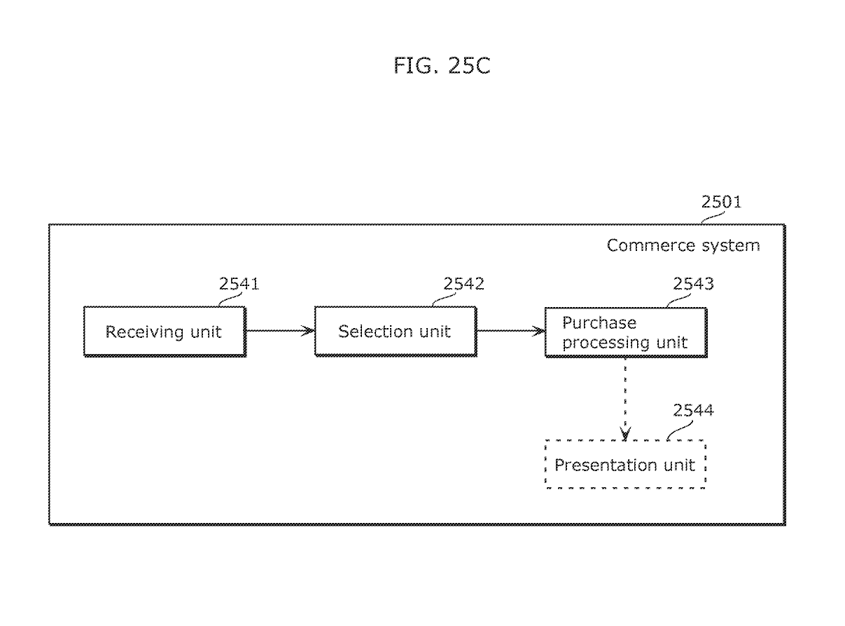

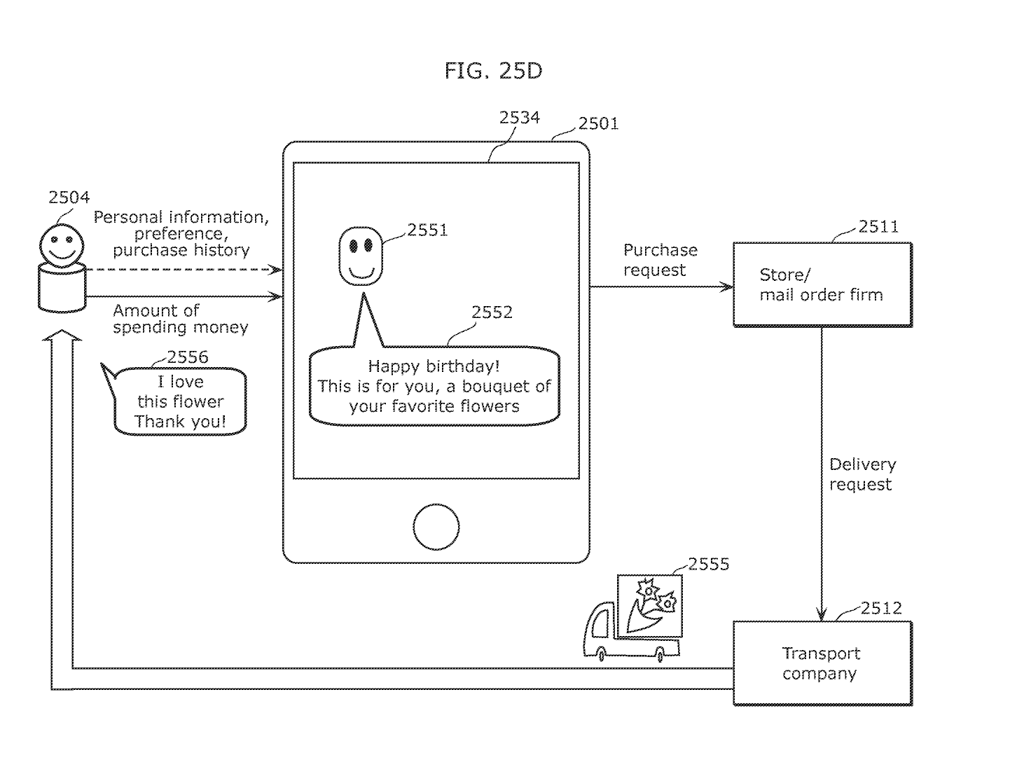

The following shows, with reference to FIGS. 25A to 30, an example in which not only preference information of a viewer is accumulated in the distribution system and is utilized, but also various acts of a user are supported via an object which a viewer easily understands. This variation further has a feature that this object is allowed to be given money and its equivalent that can be utilized in real society (pocket money) as disposable money. It should be noted that an object may be an image object displayed on a display screen of an information terminal, or an item in the real world (such as a humanoid robot or another type of robot, for example). It should be noted that the description below is given assuming that an object is a “steward” that is a character displayed on the display screen of an information terminal as an image object, as an example.

The permitted disposable money is paid by being included in, for example, payment for a credit card of a user or as a part of utilization charges of a mobile phone. In other words, a method of paying the permitted disposable money can be previously set by a user. The steward performs actual commercial transaction which does not require permission from a user, independently of the user's intention. The following is a detailed description.

FIG. 25A illustrates an example of a first configuration of an electronic commerce system according to this variation. FIG. 25A illustrates an example of the configuration of an electronic commerce system achieved through information processing using a steward programmed in a TV which understands a viewer and/or a mobile phone terminal, and an example of the electronic commerce in the electronic commerce system.

As illustrated in FIG. 25A, an electronic commerce system 2501 (hereinafter, also simply referred to as a commerce system) has a configuration connected to a store/mail-order firm 2511, and a transport company 2512 via a network 2513. A user 2504 purchases a product or a service through the commerce system 2501.

FIG. 25B illustrates an example of a hardware configuration of the electronic commerce system according to this variation. The same constituent elements as those in the distribution system in FIG. 3A are given the same numerals, and thus a detailed description thereof is omitted. As illustrated in FIG. 25B, the commerce system 2501 includes the CPU 3011, the ROM 3012, the RAM 3013, the storage device 3014, the NIC 3015, an input unit 2531, a camera 2532, a global positioning system (GPS) sensor 2533, a display screen 2534, and a speaker 2535.

The input unit 2531 receives input of information from a user. Examples of the input unit 2531 include a keyboard, a mouse, and others. Another example of the input unit 2531 is a software-based keyboard displayed on the display screen 2534.

The camera 2532 captures an image of a user.

The GPS sensor 2533 utilizes GPS to obtain the position on the earth.

The display screen 2534 displays an image. An image includes a text, a drawing, a picture, and others.

The speaker 2535 outputs sound.

It should be noted that the commerce system 2501 may include plural apparatuses. In that case, it is sufficient that at least one of the plural apparatuses includes the above constituent elements. In addition, even if some of the constituent elements such as a GPS sensor and a display screen are not included, such constituent elements may not be included if the commerce system 2501 sufficiently operates.

As illustrated in FIG. 25C, the commerce system 2501 includes a receiving unit 2541, a selection unit 2542, and a purchase processing unit 2543. Furthermore, the commerce system 2501 may include a presentation unit 2544.

The receiving unit 2541 receives from a user an amount of disposable money the usage of which is not determined. Here, the “usage of money is not determined” means that a product or a service to be purchased using the received disposable money is not determined yet. In addition, if a new amount of disposable money the usage of which is not determined is received from a user, the receiving unit 2541 increases the amount of disposable money by the new amount of disposable money. It should be noted that the receiving unit 2541 is achieved by the CPU 3011, the ROM 3012, the RAM 3013, the input unit 2531, and others.

The selection unit 2542 selects a product or a service having a purchase price lower than or equal to the amount of disposable money or less, without receiving a user instruction. Here, “selects . . . without receiving a user instruction” means that instructions from a user are not received as to the entire or partial determination of selecting when, where, and which product or service is to be purchased. In addition, the selection unit 2542 may collect and store preference and a purchase history of a user and others, and select a product or a service to purchase based on the stored collection. The selection unit 2542 is achieved by the CPU 3011, the ROM 3012, the RAM 3013, and others.

The purchase processing unit 2543 performs processing of purchasing the selected product or service without obtaining permission from a user. Here, “performs . . . without obtaining permission from a user” means that permission from a user is not obtained to perform purchase processing. “Purchase processing” includes processing of placing an order for a product or a service, processing of settling the bill for the ordered product or service, and others. In addition, the purchase processing unit 2543 decreases the amount of disposable money by a price of a product or a service purchased through purchase processing. The purchase processing unit 2543 is achieved by the CPU 3011, the ROM 3012, the RAM 3013, the NIC 3015, and others.

The presentation unit 2544 presents a user an object which can be recognized by the user. In addition, the presentation unit 2544 presents the user information indicating that the object has performed purchase processing if purchase processing is performed. The presentation unit 2544 is achieved by the CPU 3011, the ROM 3012, the RAM 3013, the display screen 2534, the speaker 2535, and others.

The commerce system 2501 has a function of executing at least one of the following: processing of collecting and storing information of a user such as personal information (a name, a birth date, or an address, also referred to as profile information), preference, a purchase history; processing of freely determining a present for a user purchased using spending money; processing of making, to a mail-order firm, a purchase request for the present and a request for delivering the present to the user; and processing of notifying the user that there is a present when a present is to arrive.

FIG. 25D is an explanatory diagram of operation of an electronic commerce system according to this variation. FIG. 25D illustrates an example in which the commerce system 2501 having all the above functions purchases a bouquet of user's favorite flowers on a birthday of the user, at a store/mail-order firm, requests delivery on the designated date and time, and gives the user the flower bouquet, thereby pleasing the user.

First, the user 2504 previously inputs to the commerce system 2501 personal information including information about his/her birthday and others, and information indicating the amount of spending money (amount of disposable money).

The commerce system 2501 receives the information inputted in the above. In addition, the commerce system 2501 performs processing of purchasing a flower bouquet at the store/mail-order firm 2511 for the user's birthday. The store/mail-order firm 2511 requests the transport company 2512 to deliver the purchased flower bouquet. The transport company 2512 delivers a flower bouquet 2555 to the user. The user 2504 receives the delivered flower bouquet.

It should be noted that delivery information may be obtained from a transport company terminal that manages delivery information indicating which point of a delivery path the flower bouquet is at in the process of delivering the flower bouquet purchased by the purchase processing, and the time when the flower bouquet is to arrive at a destination may be estimated based on the obtained delivery information. Then, a message 2552 including that the flower bouquet has reached may be presented from a steward 2551 to the user 2504 at a delivery time.

Furthermore, the commerce system may obtain a message 2556 as a reaction of the user 2504 to the delivered flower bouquet. FIG. 25D illustrates an example of the message 2556 indicating that the user 2504 has a favorable impression on the delivered flower bouquet.

In addition, for a user who does not read a book often, the commerce system 2501 purchases a book at a mail order site, and has the book sent to the user, thereby motivating the user to read a book. In this case, whether a user often reads a book can be determined based on a purchase history of the user at a mail order site, or can be determined using a GPS sensor whether the user often has a chance to drop in at a bookstore.

Furthermore, purchasing not only a product such as a flower bouquet or a book, but a service is included in the technical scope of the present invention. Specifically, the commerce system 2501 can prompt a desk-bound user to have a massage periodically, prompt a user whose eating habits are poor to see a dentist, and have a boxed lunch to be delivered to a user living alone.

For example, a steward may be supplied to a user as one application of Android (registered trademark) mobile terminal, and a part of a monthly usage fee of the application may be allocated as spending money (disposable income) of the steward. In addition, according to which steward a user selects, a monthly usage fee of an application and spending money of a steward may be set. A configuration may be adopted in which more spending money is assigned to a steward considered by the user to be highly worthy.

Any method may be used to set spending money of a steward, as long as a user is charged at the end, and thus various methods other than the above are possible. A user may give a predetermined amount of money as spending money using a prepaid system. Alternatively, a bank account may be made for a steward, and a predetermined amount of money may be transferred to the account every month. A credit card with a limit of a certain amount of money may be issued for a steward.

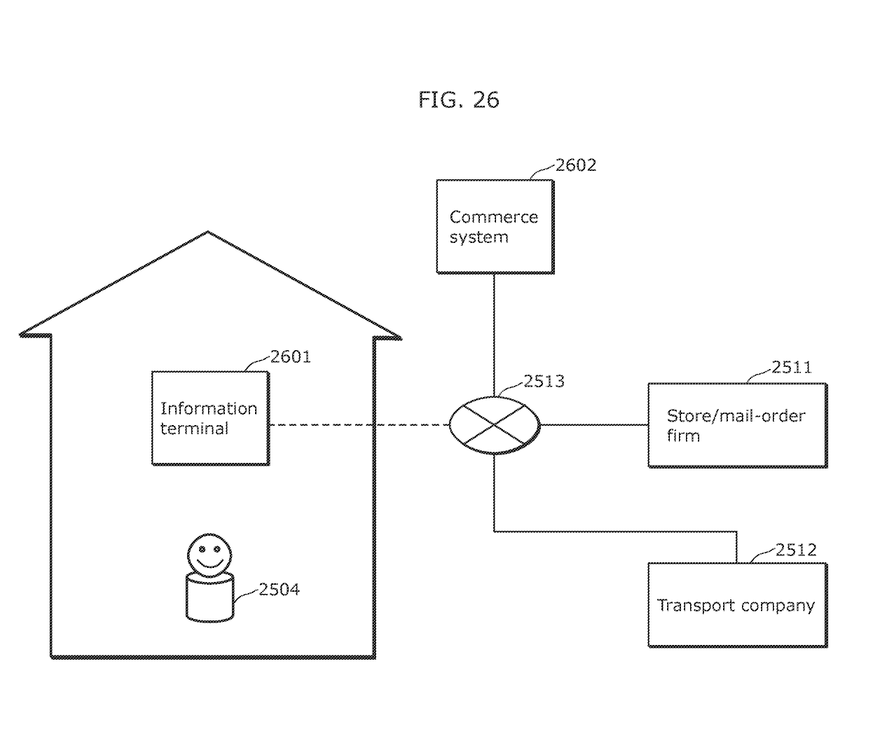

FIG. 26 illustrates an example of a second configuration of an electronic commerce system according to this variation. FIG. 26 illustrates a case where an information terminal 2601 of a user does not include a program for controlling a steward, and the program is executed as a commerce system 2602 on the cloud server of a steward management company. An environment in which a program is executed has merely changed from the user's terminal to the cloud. The details of processing and a flow performed by the program do not change.

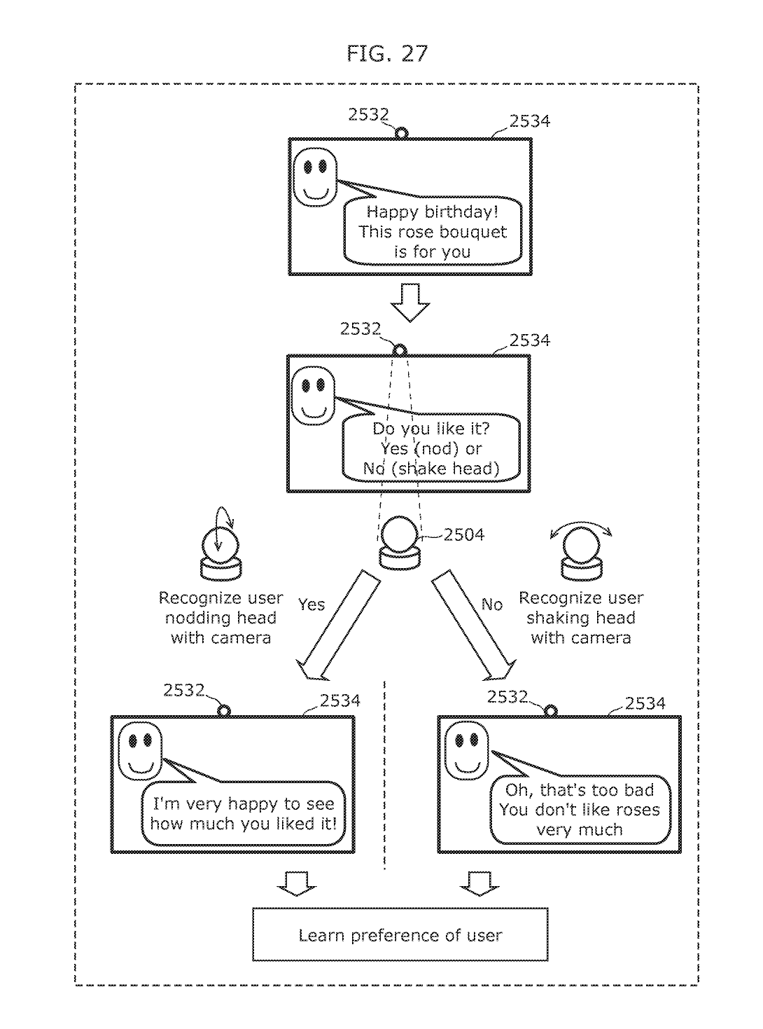

FIG. 27 illustrates an example of study of personal preference in an electronic commerce system according to this variation. FIG. 27 illustrates a method of obtaining an interest and preference of a user. FIG. 27 illustrates the camera 2532 and the display screen 2534, among the constituent elements of the commerce system 2501. A steward is displayed on the display screen 2534.

As in FIG. 25D, if a steward gives a present to a user, (a control program of) the steward asks what the user has thought of the act.

In the example as illustrated in FIG. 25D, the steward asks the user whether he/she is pleased with a rose bouquet as a gift for the birthday can be expressed by the user nodding or shaking his/her head. Here, image recognition is performed using a camera near the screen, to capture the inclination of the user's face, and if the face inclines in a longitudinal direction (Yes in FIG. 27), the steward presents a message such as “I am very happy!” (for example, by display, sound, and the like). How much the user is satisfied is quantified and recorded based on the angle or count of such nodding, which allows (the control program of) the steward to quantify the fact that the user is pleased with the rose bouquet and preference information indicating how much the user is pleased, and store and learn the quantified data.

On the other hand, if it is recognized that the user has shaken his/her head horizontally (No in FIG. 27), a message such as “That's too bad” is presented. As with the description given above, based on the angle or count of such shaking his/her head, how much the user dislikes the bouquet is quantified and recorded, which allows (the control program of) the steward to quantify a fact that the user is not pleased with the rose bouquet and preference information indicating how much the user dislikes, and store and learn the quantified data.

Repetitions of such learning allow (the control program of) the steward to appropriately respond to preference of a user. The user develops a relationship of trust with the steward that understands the user's preference and that the user enjoy its growth, as if the steward is an actual person, and thus allocates more spending money, or the user can expect to achieve a wider variety of actions so that the steward can select its action from more options.

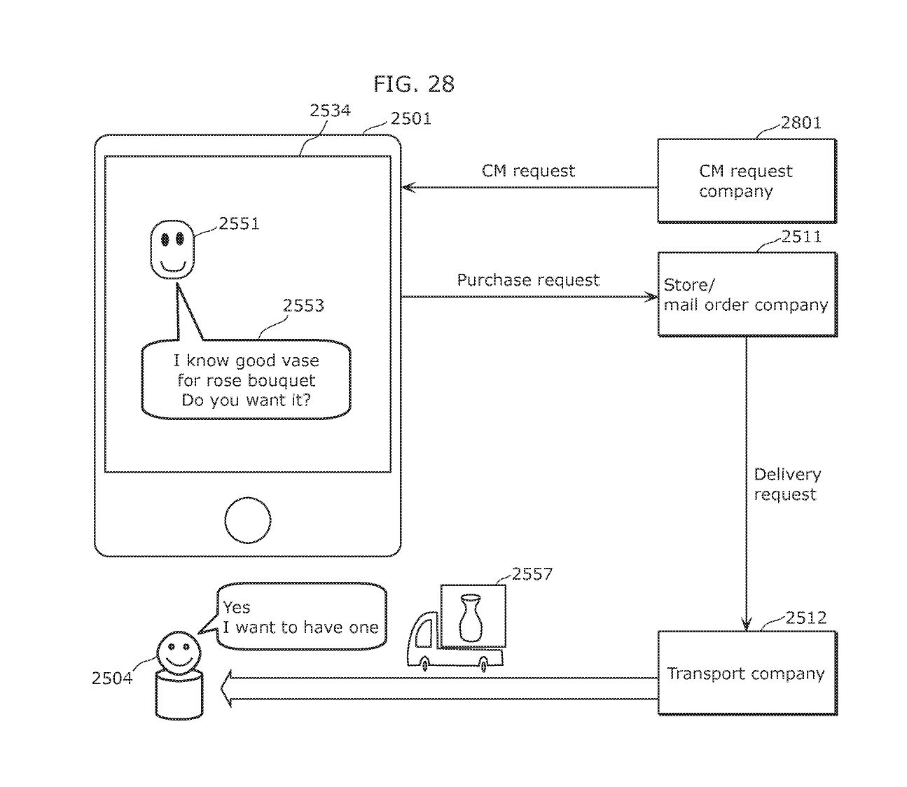

FIG. 28 illustrates an example of optimization of an advertisement in the electronic commerce system according to this variation. FIG. 28 illustrates an example of a program (information processing) which more effectively appeals to a user through an advertisement using an expressional subject or namely a steward with which the user has established a relationship of trust.

Based on a request from a CM request company 2801, (information processing by) a steward management company determines a steward that conveys a CM. The steward conveys a CM to a user to advertise a product or a service, for instance. The steward may make a purchase dogmatically without asking a user if the price is not over spending money (amount of disposable money) of the steward. If the user consents the purchase, the steward makes a purchase via a store/mail-order firm, and requests the store/mail-order firm to deliver the product to the user's house.

Through (information processing by) the CM request company, the management company is requested to convey a CM, and CM charge is paid (CM charge may be paid from the shared profits from sales). It is also possible to designate to whom a CM is to be conveyed such as many unspecified persons or a steward having a specific profile.

For example, suppose that the CM request company 2801 has a request from a flower vase manufacturing company to advertise a flower vase to a person given a bouquet recently. If such a request is made to (a control program of) a steward management company, (the control program of) the steward management company can extract persons such as a person who has purchased a bouquet recently and a person given a bouquet from a database, and make an advertisement to such people using their stewards.

In FIG. 28, a steward presents, a user for whom a rose bouquet has been purchased as a birthday present, to a message 2553 recommending the user to purchase a flower vase which suits the rose bouquet, and a flower vase 2557 is delivered to the user. Although the whole of this processing is mechanical processing executed by the control program on the server of the steward management company, the relationship of trust between the user and the steward has been established which allows expectations of appeals different from an advertisement made by a third party.

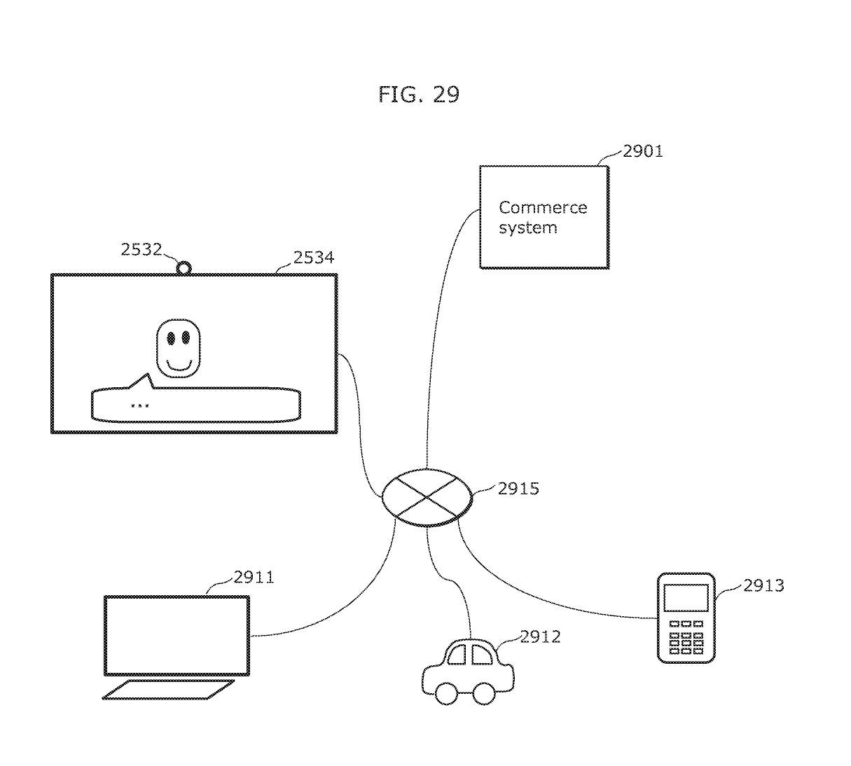

FIG. 29 illustrates an example in which the electronic commerce system according to this variation learns personal actions. FIG. 29 illustrates an example in which a steward in the commerce system 2501 more understands actions of a user taken inside or outside the user's house. For example, a Web browser history or a product purchase history using a television or a personal computer in a house, and others, and in addition, user's actions including a mobile phone use history outside the house (GPS, Osaifu-Keitai (registered trademark) (mobile wallet), e-mail transmission and reception, or a call history), a driving history (position information), and others are collected and stored, and the steward may be caused to give a comment to and have a conversation with a user who comes home regarding actions taken by the user outside. For example, the steward in the commerce system 2501 may say a message such as “You finally bought it! Let's play it now.”

The commerce system 2501 may be offered to a user as, for example, one application of an Android (registered trademark) mobile terminal in order to collect a history of user actions. A user carries a mobile terminal also outside the house, and thus the commerce system 2501 can collect information regarding where the user is out in conjunction with GPS information of the mobile terminal. In addition, the commerce system 2501 analyzes transmission and reception of e-mails, thereby collecting information regarding whom the user exchanges information with and what the information is about. In addition, the commerce system 2501 may collect a history of actions taken by the user outside his/her house, such as what the user has bought in conjunction with Mobile Wallet.

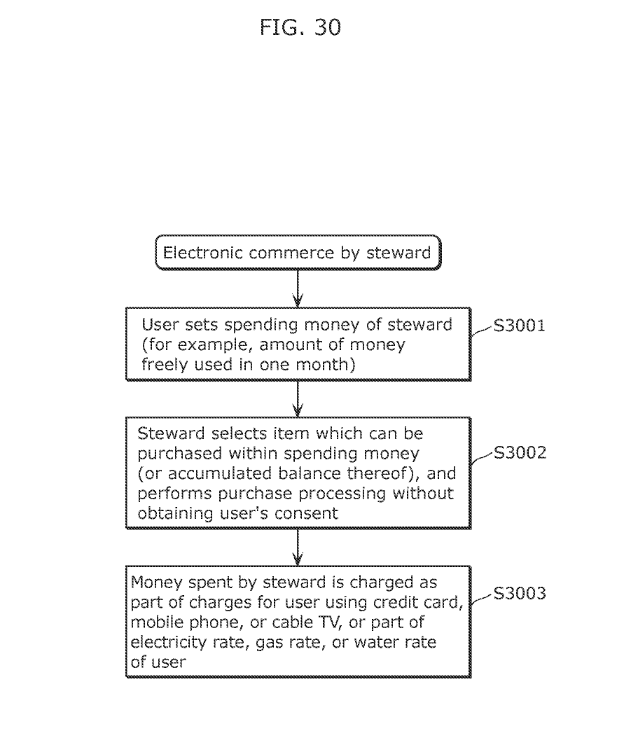

FIG. 30 illustrates an example of accounting processing in the electronic commerce system according to the variation of the embodiment. FIG. 30 illustrates accounting processing in e-commerce by a steward.

First, the user sets spending money of a steward (step S3001).

Next, the steward selects an item which can be purchased within the range of spending money, and performs purchase processing (commercial transaction) without obtaining user's consent (step S3002).

Next, the user is charged for the money spent by the steward. Specifically, the money spent by the steward is charged as a part of charges for using a credit card, a mobile phone, or cable TV, or a part of electricity rate, gas rate, or water rate (step S3003).

Although a product purchased by a steward is expected to be for a user in the above examples, the present invention is not limited to this, and a steward may spend money for itself if the price is within a certain amount of money. For example, assuming that a steward goes to a virtual beauty salon to change its hairstyle, a charge may be made therefor, and a video of the steward with a different hairstyle than before may be displayed, or the steward may donate money for earthquake disaster reconstruction. In other words, a steward can pay money for a product or a service if the price is within a certain amount of money permitted by the user, independently of the user intention, or in other words, without the necessity of user's consent.

It should be noted that a control program of the steward may be set such that if a steward is to purchase a highly priced product and this results in an excess of spending money, a step of asking the user as to whether the user allows the purchase, and then if the user permits the purchase, the steward purchases the product.

It should be noted that a monetary sense of a steward may be set as initial settings. Then, plural candidates for such a monetary sense may be prepared. For example, a configuration may be adopted in which a user can select various settings such as a steward that has a monetary sense according to which the steward roughly spends money and is self-centered and bold, a steward that has a monetary sense according to which the steward spends money only for a product or service for a user and is conservative and prudent, a steward that has a steady monetary sense according to which the steward saves spending money little by little, and purchases a highly priced product that exceeds the amount of spending money for each month. In addition, such settings may be changed as time elapses while checking a user reaction. User reactions may be collected when the user checks what the steward has used the spending money for, by using a camera of a mobile terminal to recognize his/her facial expression and analyzing the voice at that time.

It should be noted that a setting may be set such that only one steward is in this world, and plural terminals of a user cannot simultaneously call (display) the steward. This may be achieved by communications between programs running on terminals of the user.

It should be noted that an object does not necessarily need to be recognized by a user, and an information terminal may have a function equivalent to the above (without using an object).

As described above, according to an electronic commerce method according to the present embodiment, processing of purchasing a product or a service may be performed using an amount of disposable money the usage of which is not determined by the user, without permission from a user. After that, the user is provided with a product or a service purchased using the disposable money the usage of which is not determined by the user, without his/her consent. Thus, a product or a service beyond the range of knowledge of the user greatly changes the user's mental state by obtaining knowledge and experience beyond the range of his/her knowledge. Specifically, the user can obtain unknown experience, surprise, joy, happiness, satisfaction, pleasure, and others. In this manner, a user establishes a relationship of trust with an object, which leads to an expectation that the user permits more disposable money to an object.

It should be noted that the present invention can also provide an electronic commerce method according to which processing load in purchase processing is reduced. This is because, in conventional purchase processing, processing of receiving, from a user, information regarding a product or a service to be purchased is performed, whereas such processing is not performed according to the present invention, and thus processing load can be reduced by that processing.

In addition, a user is presented information from an object as if the object has purchased a product or a service. The user feels that the object has selected and purchased the product or the service with its intention, and feels closeness, affection, and gratitude to the object. Therefore, the mental state of the user is more greatly changed.

In addition, a product or a service is selected and purchased based on profile information such as the birthday or a blood type of a user. For the user, a product or a service is purchased based on his/her own profile (for example, a rose bouquet is given on the user's birthday), thereby greatly changing his/her mental state.

In addition, a product or a service is selected and purchased after that, based on a reaction of a user after providing the user with a product or a service. This helps learning preference of the user, and leads to a selection of a product or a service to more greatly change the user's mental state (affection and gratitude).

In addition, if a product is purchased, a message is presented at a time when the product is delivered to the location of a user. Although the product is delivered by a deliveryman of a transport company in fact, the user can feel that the product is provided by the object.

In addition, purchase of a product or a service is recommended to a user based on advertisement information. In other words, an advertisement company which wishes to recommend a user to purchase a product or a service can recommend a user to purchase the product or the service by providing advertisement information.

In addition, the amount of disposable money can be increased or decreased. A user sets a new amount of disposable money, which allows a more highly priced product or service to be purchased.

In addition, an object is achieved as an image object on the display screen of a computer. A user feels a sense of trust toward this image object through the exchange of information or messages therewith, which leads to a great change in his/her mental state. In addition, an increase in the sense of trust leads to a purchase of a more highly priced product or service.

In addition, an object is achieved as a robot in the a world. A user feels a sense of trust through the exchange of information or messages with this robot, which greatly changes the mental state of the user. In addition, an increase in the sense of trust leads to a purchase of a more highly priced product or service.

It should be noted that since the above description is merely an example, the present invention should not be limited to the above description, and various applications are possible.

It should be noted that in the above embodiments, each of the constituent elements may be constituted by dedicated hardware, or may be obtained by executing a software program suitable for the constituent element. Each constituent element may be obtained by a program execution unit such as a CPU or a processor reading and executing a software program recorded on a recording medium such as a hard disk or semiconductor memory.

Specifically, this program causes a computer to execute an electronic commerce method, the electronic commerce method including: receiving, from a user, an amount of disposable money usage of which is not determined; selecting, from among one or more products or services, a product or a service having a purchase price lower than or equal to the amount of disposable money, without receiving an instruction from the user; and performing purchase processing of purchasing the product or the service which has been selected, without obtaining permission from the user.

Although the above is a description of an electronic commerce method according to one or more aspects based on the embodiments, the present invention is not limited to the embodiments. Various modifications to the embodiments that may be conceived by those skilled in the art and combinations of constituent elements in different embodiments may be included within the scope of the one or more aspects, as long as the modifications and combinations do not depart from the spirit of the present invention.

### INDUSTRIAL APPLICABILITY

The present invention can collect, store, and provide various types of information in formats that sufficiently satisfy customer needs when providing an information delivery service. In addition, the present invention has advantages that in electronic commerce, the mental state of a user can be greatly changed, and processing load in purchase processing can be reduced.

### REFERENCE SIGNS LIST

101, 201, 301 Distribution system
111 Content producer
112 Video distributor
113, 213, 2313, 2413 Sponsor
114, 215, 2315, 2415 Viewer (viewer terminal)
211, 2311, 2411 Content holder
212, 312, 1801, 2312, 2412 Distributor
214, 2314, 2414 Store
303 Information processing unit
304 Management information unit
305 Content related information
306 Sponsor related information
307 Viewer related information
308 Store related information
311A Content holder A
311B Content holder B
313A Sponsor A
313B Sponsor B
314×Store X
314Y Store Y
315A, 1802 Viewer A
315B, 1803 Viewer B
1804 Viewer C
2501, 2602, 2901 Electronic commerce system (commerce system)
2504 User
2511 Store/mail-order firm
2512 Transport company
2513, 2915 Network
2531 Input unit
2532 Camera
2533 GPS sensor
2534 Display screen
2535 Speaker
2541 Receiving unit
2542 Selection unit
2543 Purchase processing unit
2544 Presentation unit
2551 Steward
2552, 2553, 2556 Message
2601 Information terminal
2801 CM request company
2911 Television
2912 Car
2913 Mobile phone
3011 CPU
3012 ROM
3013 RAM
3014 Storage device
3015 NIC

1. An electronic commerce method executed by a computer, the electronic commerce method comprising:
receiving, from a user, an amount of disposable money usage of which is not determined;
selecting, from among one or more products or services, a product or a service having a purchase price lower than or equal to the amount of disposable money, without receiving an instruction from the user; and
performing purchase processing of purchasing the product or the service which has been selected, without obtaining permission from the user.

2. The electronic commerce method according to claim 1, further comprising:
presenting, to the user, an object recognizable by the user; and
notifying the user, when the purchase processing is performed, that the object has performed the purchase processing.

3. The electronic commerce method according to claim 1, further comprising:
receiving profile information of the user; and
selecting, when the product or the service is to be selected, the product or the service based on the received profile information.

4. The electronic commerce method according to claim 1, further comprising:
obtaining a reaction of the user to the product or the service purchased by the purchase processing; and
selecting, when the product or the service is to be selected after obtaining the reaction of the user, the product or the service based on the obtained reaction of the user.

5. The electronic commerce method according to claim 1, further comprising
notifying the user that the product has been purchased if the product is purchased by the purchase processing, at (i) a time designated as a time on a delivery date for the product or (ii) a time at which the product is to arrive at a destination of the product, the time being estimated based on delivery information indicating which point of a delivery path the product is at in a process of delivering the product purchased by the purchase processing, the delivery information being obtained from a transport company terminal which manages the delivery information.

6. The electronic commerce method according to claim 1, further comprising:
obtaining advertisement information regarding an advertisement of a product or a service, from an advertisement company terminal; and
notifying the user of recommendation to purchase the product or the service indicated by the obtained advertisement information.

7. The electronic commerce method according to claim 1, further comprising:
decreasing, if the purchase processing is performed, the amount of disposable money by the purchase price of the product or the service purchased by the purchase processing; and
increasing, if a new amount of disposable money usage of which is not determined is received from the user, the amount of disposable money by the new amount of disposable money.

8. The electronic commerce method according to claim 2,
wherein a terminal used by the user in the electronic commerce method has a display screen, and
the object is an image object displayed as an image on the display screen of the terminal, and notifies the user that the object has performed the purchase processing, by a motion of or a sound from the image.

9. The electronic commerce method according to claim 2,
wherein the object is a robot in a real space, and notifies the user that the object has performed the purchase processing, by a motion of or a sound from the robot.

10. An electronic commerce system comprising:
a receiving unit configured to receive, from a user, an amount of disposable money usage of which is not determined;
a selection unit configured to select, from among one or more products or services, a product or a service having a purchase price lower than or equal to the amount of disposable money, without receiving an instruction from the user; and
a purchase processing unit configured to perform processing of purchasing the product or the service which has been selected, without obtaining permission from the user.
